(19) United States
(12) Patent Application Publication
(10) Pub. No.: US 2022/0334543 A1
(43) Pub. Date: Oct. 20, 2022

(54) SMART DEVICE CONTROL SYSTEM, METHOD, AND APPARATUS, SMART GATEWAY, AND STORAGE MEDIUM

(71) Applicant: BOE Technology Group Co., Ltd., Beijing (CN)

(72) Inventors: Qian ZHANG, Beijing (CN); Junjie ZHAO, Beijing (CN); Yanqiu ZHAO, Beijing (CN); Jing SU, Beijing (CN)

(21) Appl. No.: 17/856,267

(22) Filed: Jul. 1, 2022

Related U.S. Application Data
(63) Continuation of application No. PCT/CN2020/141521, filed on Dec. 30, 2020.

(30) Foreign Application Priority Data
Jan. 8, 2020 (CN) 202010019530.6

(51) Int. Cl. G05B 15/02

(52) U.S. Cl. CPC G05B 15/02

(57) ABSTRACT

A system, method and apparatus for controlling a smart device, a smart gateway and a storage medium, wherein the method includes: receiving first monitored data provided by a first sensor; determining a relation that the first monitored data and a preset target monitored numerical value satisfy; determining an action resource among a plurality of preset action resources that contains a triggering condition matching with the relation as a first action resource; extracting an execution instruction from the first action resource, and sending the execution instruction to a first smart device related to the first action resource; and according to the first monitored data, monitoring a first execution effect of the first smart device related to the first action resource, and according to the first execution effect, starting up a second smart device related to the first smart device or shutting down the first smart device.

### CROSS REFERENCE TO RELEVANT APPLICATIONS

The present disclosure claims the priority of the Chinese patent application filed on Jan. 8, 2020 with the application number of 202010019530.6, which is incorporated herein in its entirety by reference.

### TECHNICAL FIELD

The present disclosure relates to the technical field of smart devices, and particularly relates to a system, method and apparatus for controlling a smart device, a smart gateway and a storage medium.

### BACKGROUND

Smart devices have already been extensively applied. Currently, regarding the controlling on a plurality of smart devices in the same one controlling system, in the controlling of each of the smart devices, it is difficult to take into consideration the other devices.

### SUMMARY

In the first aspect, an embodiment of the present disclosure provides a method for controlling a smart device, wherein the method comprises: receiving first monitored data provided by a first sensor; determining a relation that the first monitored data and a preset target monitored numerical value satisfy; determining an action resource among a plurality of preset action resources that contains a triggering condition matching with the relation as a first action resource; extracting an execution instruction from the first action resource, and sending the execution instruction to a first smart device related to the first action resource; and according to the first monitored data, monitoring a first execution effect of the first smart device related to the first action resource, and according to the first execution effect, starting up a second smart device related to the first smart device or shutting down the first smart device.

Optionally, the method further comprises: when the first monitored data provided by the first sensor trigger a second action resource, extracting a functioning duration of the second action resource from the second action resource, and extracting a functioning duration of the first action resource from the first action resource; if a current moment falls within a time period of the functioning duration of the first action resource, continuing executing the first action resource, and terminating executing the second action resource; and if a current moment falls within a time period of the functioning duration of the second action resource, executing the second action resource, and terminating executing the first action resource.

Optionally, the first action resource contains first action-effect information, and the first action-effect information contains a first effect monitoring period, a first starting effect numerical value, a first current effect numerical value, a first target effect numerical value and a first effect controlling trend; and the step of, according to the first monitored data, monitoring the first execution effect of the first smart device related to the first action resource comprises: according to the first monitored data, updating the first starting effect numerical value in the first action-effect information, and according to the target monitored numerical value, updating the first target effect numerical value in the first action-effect information; according to the first effect monitoring period in the first action-effect information, receiving the first monitored data, according to the received first monitored data, updating the first current effect numerical value in the first action-effect information, and according to the first starting effect numerical value and the first target effect numerical value, determining a current-moment-predicted-reached numerical value, according to a relation between the updated first current effect numerical value and the current-moment-predicted-reached numerical value, determining whether the first execution effect is out-of-control or under-control, and updating a determination result to a status value of the first effect controlling trend in the first action-effect information; if the first execution effect is under-control, then continuing detection in a next period; and if the first execution effect is out-of-control, then starting up the second smart device or, according to the first execution effect, selecting another action resource from the plurality of predetermined action resources as the first action resource.

Optionally, the first action-effect information further contains a first effect-predicted-reached period; and the step of, according to the first starting effect numerical value and the first target effect numerical value, determining the current-moment-predicted-reached numerical value comprises: according to the first starting effect numerical value and the first target effect numerical value, and according to the first effect-predicted-reached period and the first effect monitoring period, determining a predictively reached effect; and according to a time difference between a current moment and an initial moment and the predictively reached effect, determining the current-moment-predicted-reached numerical value, wherein the initial moment is a moment of sending the execution instruction in the first action resource.

Optionally, the first action-effect information further contains a first effect controlling parameter; and the step of, according to the relation between the updated first current effect numerical value and the current-moment-predicted-reached numerical value, determining whether the first execution effect is out-of-control or under-control comprises: according to the first effect controlling parameter in the first action-effect information and the current-moment-predicted-reached numerical value, determining an upper limit of the current-moment-predicted-reached numerical value and a lower limit of the current-moment-predicted-reached numerical value; and according to a relation between the updated first current effect numerical value and the upper limit of the current-moment-predicted-reached numerical value and the lower limit of the current-moment-predicted-reached numerical value, determining whether the first execution effect is out-of-control.

Optionally, the first action resource further contains second action-effect information; the method further comprises: receiving second monitored data provided by a second sensor; and the step of, according to the first monitored data, monitoring the first execution effect of the first smart device related to the first action resource, and according to the first execution effect, shutting down the first smart device comprises: according to the second monitored data, monitoring a second execution effect of the first smart device related to the first action resource, and updating the second action-effect information in the first action resource corresponding to the second execution effect; and when a difference between the second execution effect and a predetermined effect exceeds a predetermined range, determining that the second execution effect is out-of-control, and according to the second execution effect, shutting down the first smart device.

Optionally, the method further comprises: triggering, by the received first monitored data provided by the first sensor, the second action resource, wherein the second action resource comprises third action-effect information, and the third action-effect information contains a second target effect numerical value; and the method further comprises: according to the triggering condition in the first action resource and the first target effect numerical value in the first action-effect information in the first action resource, determining a first effect trend corresponding to the first action resource, and according to the triggering condition in the second action resource and the second target effect numerical value in the third action-effect information in the second action resource, determining a second effect trend corresponding to the second action resource; when the first effect trend corresponding to the first action resource and the second effect trend corresponding to the second action resource are opposite, determining whether a status value of a parameter of no-same-effect in the second action resource is true, and whether a status value of a parameter of no-opposite-effect is false; and when the status value of the parameter of no-same-effect is true and the status value of the parameter of no-opposite-effect is false, determining whether an execution object in the first action resource and an execution object in the second action resource are a same one object, if yes, then continuing executing the first action resource, and terminating executing the second action resource, and if no, then continuing executing the first action resource, and starting to execute the second action resource.

Optionally, the first action-effect information is stored as a sub-resource of the first action resource, or is stored as a parameter of the first action resource; and the triggering condition in the first action resource is stored as a parameter of the first action resource.

Optionally, the first action resource further contains first checking information, and the first checking information is stored as a sub-resource of the first action resource.

Optionally, the method further comprises: receiving a triggering instruction inputted by a user, and extracting the preset target monitored numerical value from the received triggering instruction.

In the second aspect, an embodiment of the present disclosure further provides an apparatus for controlling a smart device, wherein the apparatus comprises: a data receiving module configured for receiving first monitored data provided by a first sensor; an action-resource determining module configured for determining a relation that the first monitored data and a preset target monitored numerical value satisfy; and determining an action resource among a plurality of preset action resources that contains a triggering condition matching with the relation as a first action resource, and extracting an execution instruction from the first action resource, and sending the execution instruction to a first smart device related to the first action resource; and a monitoring module configured for, according to the first monitored data, monitoring a first execution effect of the first smart device related to the first action resource, and according to the first execution effect, starting up a second smart device related to the first smart device or shutting down the first smart device.

Optionally, the monitoring module is further configured for, when the first monitored data provided by the first sensor trigger a second action resource, extracting a functioning duration of the second action resource from the second action resource, and extracting a functioning duration of the first action resource from the first action resource; if a current moment falls within a time period of the functioning duration of the first action resource, continuing executing the first action resource, and terminating executing the second action resource; and if a current moment falls within a time period of the functioning duration of the second action resource, executing the second action resource, and terminating executing the first action resource.

Optionally, the data receiving module is further configured for receiving second monitored data provided by a second sensor.

In the third aspect, an embodiment of the present disclosure further provides a smart gateway, wherein the smart gateway comprises: a processor; and a memory, wherein the memory is communicatively connected to the processor; wherein the memory stores at least one instruction, and the at least one instruction, when executed by the processor, is configured for implementing the method for controlling a smart device according to any one of claims 1-10.

In the fourth aspect, an embodiment of the present disclosure further provides a system for controlling a smart device, wherein the system comprises: the smart gateway stated above; the first sensor, communicatively connected to the smart gateway, configured for continuously collecting the first monitored data and sending the first monitored data to the smart gateway; and a terminal device, communicatively connected to the smart gateway, configured for providing a triggering instruction to the smart gateway, wherein the triggering instruction contains a target monitored numerical value of a same type as a type of the monitored data.

Optionally, the system further comprises: a second sensor, communicatively connected to the smart gateway, configured for continuously collecting second monitored data and sending the second monitored data to the smart gateway.

In the fifth aspect, an embodiment of the present disclosure further provides a computer-readable storage medium, storing a computer program, wherein the computer program, when executed by a processor, implements the method for controlling a smart device stated above.

### BRIEF DESCRIPTION OF THE DRAWINGS

The above and/or additional aspects and advantages of the present disclosure will become apparent and readily understandable from the following description on the embodiments with reference to the drawings. In the drawings:

FIG. 1 is a schematic diagram of the architecture of the system for controlling a smart device according to an embodiment of the present disclosure;

FIG. 2 is a schematic flow chart of the method for controlling a smart device according to an embodiment of the present disclosure;

FIG. 3A is a schematic signaling diagram of a registering method of the devices according to an embodiment of the present disclosure;

FIG. 3B is a block schematic diagram of the association relation of the resources according to an embodiment of the present disclosure;

FIG. 4A is a schematic signaling diagram of the sensor providing data according to an embodiment of the present disclosure;

FIG. 4B is a block schematic diagram of the examples of the container resource and the container according to an embodiment of the present disclosure;

FIG. 5 is a block schematic diagram of an example of the first action resource and the second action resource according to an embodiment of the present disclosure;

FIG. 6A is a schematic flow chart of the method for controlling a smart device based on an action resource according to an embodiment of the present disclosure;

FIG. 6B is a schematic flow chart of the method for monitoring an action effect according to real-time monitored data according to an embodiment of the present disclosure;

FIG. 6C is a schematic signaling diagram of an example of the method for controlling a smart device based on an action resource according to an embodiment of the present disclosure;

FIG. 7A is a schematic flow chart of the method for controlling a smart device based on an action resource according to another embodiment of the present disclosure;

FIG. 7B is a schematic diagram of the principle of the out-of-control of the average refrigeration power of an air conditioner according to an embodiment of the present disclosure;

FIG. 7C is a schematic signaling diagram of an example of the method for controlling a smart device based on an action resource according to another embodiment of the present disclosure;

FIG. 8A is a schematic flow chart of the method for controlling a smart device based on an action resource according to yet another embodiment of the present disclosure;

FIG. 8B is a schematic signaling diagram of an example of the method for controlling a smart device based on an action resource according to yet another embodiment of the present disclosure;

FIG. 9A is a schematic flow chart of the method for controlling a smart device based on an action resource according to still another embodiment of the present disclosure;

FIG. 9B is a schematic signaling diagram of an example of the method for controlling a smart device based on an action resource according to still another embodiment of the present disclosure;

FIG. 10 is a schematic structural block diagram of the apparatus for controlling a smart device according to an embodiment of the present disclosure; and

FIG. 11 is a block schematic diagram of the structure of the smart gateway according to an embodiment of the present disclosure.

### DETAILED DESCRIPTION

The present disclosure will be described in detail below, and the examples of the embodiments of the present disclosure are illustrated in the drawings, wherein the same or similar reference numbers throughout the drawings indicate the same or similar components or components having the same or similar functions. Moreover, if the detailed description of a known technical feature is not necessary for the shown features of the present disclosure, then it is omitted. The embodiments described below with reference to the drawings are exemplary, are intended to interpret the present disclosure, and should not be construed as a limitation on the present disclosure.

A person skilled in the art can understand that, unless defined otherwise, all of the terms used herein (including technical terminologies and scientific terminologies) have the meanings that are the same as those generally understood by a person skilled in the art that the present application relates to. It should also be understood that those terms such as defined in a generic dictionary should be understood as having the meanings consistent with the meanings in the context of the related art, and, unless specifically defined as used herein, should not be interpreted as having an idealized or too formal meaning.

A person skilled in the art can understand that, unless stated specifically, the singular forms “a”, “an”, “the” and “said” used herein may also include the plural forms. It should be further understood that the expression “comprise” as used in the description of the present disclosure refers to the existence of the described features, integers, steps, operations, elements and/or components, but does not exclude the existence or the addition of one or more other features, integers, steps, operations, elements and components and/or a group thereof. It should be understood that, when an element is described as being “connected” or “coupled” to another element, it may be directly connected or coupled to the another element, or there may also be an intermediate element. Moreover, the “connection” or “coupling” used herein may include wireless connection or wireless coupling. The expression “and/or” used herein includes all or any of the units of one or more related listed items and all of the combinations thereof.

The system, method and apparatus for controlling a smart device, the smart gateway and the storage medium according to the present disclosure aim at solving the technical problems in the related art.

The concept of the present disclosure is explained below by using embodiments, which are not limited to the embodiments defined below.

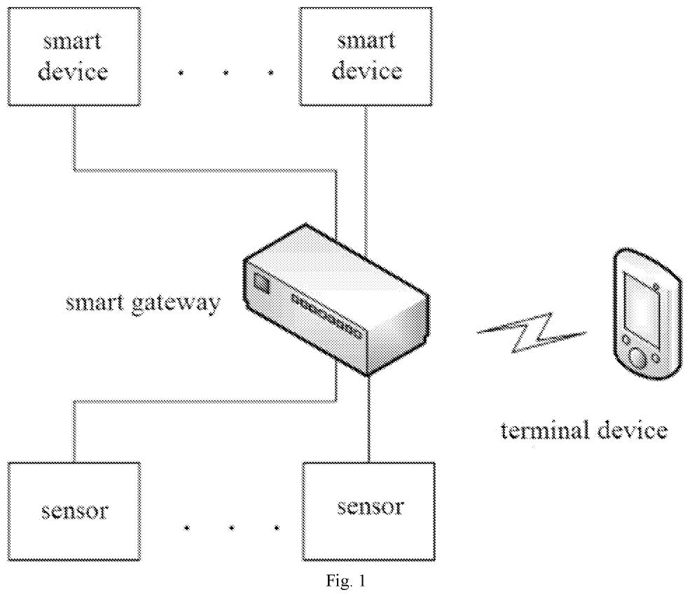

An embodiment of the present disclosure provides a system for controlling a smart device. The controlling system, as shown in FIG. 1, comprises: a smart gateway, at least one sensor, at least one smart device and at least one terminal device.

The sensor may be a sensor for detecting external-environment parameters by the user, or a sensor for detecting internal-environment parameters of a device, or a sensor for monitoring an operating state of a device. Examples include a temperature sensor, a humidity sensor, a pressure sensor, a gas-concentration sensor, a light-intensity sensor, a particle sensor, a refrigeration-power sensor and so on. The at least one sensor may be the same type of sensors, or at least two types of sensors. The quantity of each type of sensors may be one or more.

Each type of the sensors is configured for continuously collecting the monitored data in the internal or external environment of a device and reporting to the smart gateway. For example, the monitored data may contain at least one of the following: an actual-temperature numerical value of the environment, an actual refrigeration-power numerical value of an air conditioner, an actual humidity numerical value, an actual brightness numerical value, an actual particle density numerical value, switching data of a smart-lamplight device, data of the movement speed or position of a floor mopping robot, and so on.

The smart device may be a smart home, a smart industrial equipment or another type of device. For example, it may be a smart air-conditioning device, a smart refrigerating fan, a smart door-magnetism device, a smart window-magnetism device, a smart humidifier, a smart lamplight device, a smart air purifier, a floor mopping robot and so on in a smart-home scene. The quantity of each type of smart device is at least one. The at least one smart device may be at least one of one type of smart devices (for example, a plurality of refrigerating fans), or at least one of multiple types of smart devices (for example, a smart air-conditioning device and a smart refrigerating fan). Each of the smart devices may have the smart function itself, and may also be a combination of a common non-smart device and an electrically connected smart switch. Regarding such a combination, the communicative connection described below between the smart device and the smart gateway is actually a communicative connection between the smart gateway and the smart switch. For example, the smart gateway is communicatively connected to a smart air-conditioner switch, and the smart air-conditioner switch is communicatively connected to a non-smart air conditioner. As another example, the smart gateway is communicatively connected to a smart refrigerating-fan switch, and the smart air-conditioner switch is communicatively connected to a non-smart refrigerating fan.

The communicative connection according to the present disclosure includes wired connection and wireless connection. The smart device may be connected to the smart gateway wirelessly. The wireless connection method may include at least one of the following: a wireless local area network, a mobile communication network, an NFC (Near Field Communication) connection and a Bluetooth connection. The wireless local area network may be a WiFi (Wireless Fidelity) local area network and so on. The mobile communication network may be a 3G (3rd-Generation wireless telephone technology) network or an LTE (Long Term Evolution) network and so on.

The terminal device according to the embodiments of the present disclosure may be one, two or more. The terminal device has the communication function, the displaying function and the function of human-machine interaction. The terminal device may be one of the following: a smartphone, a tablet personal computer, a two-in-one computer, a notebook computer, a PDA (Personal Digital Assistant) and so on.

The smart device is communicatively connected to the smart gateway. For example, the terminal device may be connected to the smart gateway wirelessly. The wireless connection method may include at least one of the following: a wireless local area network, a mobile communication network, an NFC connection and a Bluetooth connection. The smart device is configured for, after receiving a triggering instruction, sending the triggering instruction to the smart gateway.

The smart gateway according to the embodiments of the present disclosure is mainly configured for determining real-time monitored data and a triggering condition that a target monitored numerical value in a triggering instruction satisfies, and determining the first action resource that the triggering condition belongs to; determining an execution instruction in the first action resource, and sending the execution instruction to a first smart device corresponding to the first action resource; according to the real-time monitored data, monitoring a first execution effect corresponding to the first action resource, and according to a monitoring result of the first execution effect, starting up a second smart device related to the first smart device or shutting down the first smart device; or, according to subsequent real-time monitored data, solving the conflict between the later-triggered second action resource and the first action resource.

For example, another sensor according to the embodiments of the present disclosure is configured for continuously collecting another type of monitored data and providing to the smart gateway.

For example, the smart gateway is further configured for receiving the registration of each of the sensors, each of the smart devices and each of the terminal devices, receiving and saving the data provided by each of the sensors, creating action resources (action), action-effect resources (actionDesiredEffect) and so on involved in the smart device, which will be described in detail subsequently, and is not discussed here further.

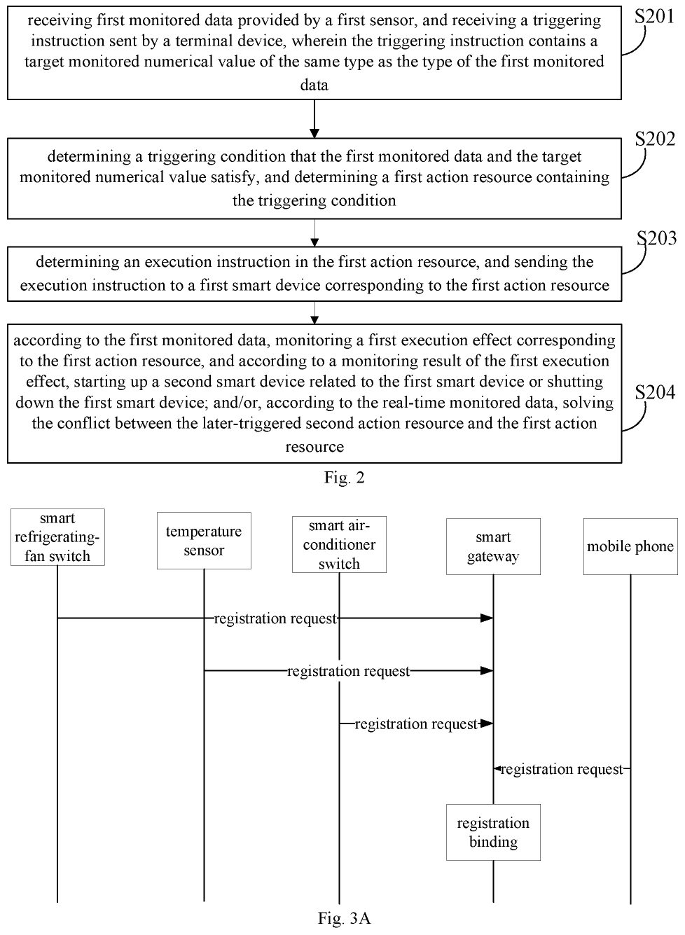

Based on the same concept, an embodiment of the present disclosure provides a method for controlling a smart device, which may be implemented by a controlling device at the network side, for example, network devices such as a processor, a server or a gateway. A schematic flow chart of the method is shown in FIG. 2, and the method comprises S201 to S204.

S201: receiving first monitored data provided by a first sensor, and extracting from a triggering instruction a preset target monitored numerical value of the same type as the type of the first monitored data.

In some embodiments, the triggering instruction may be pre-provided in the smart gateway, and may also be inputted from the terminal device by the user.

The target monitored numerical value of the same type as the type of the first monitored data refers to the data of the same data type as that of the first monitored data, and the data are the target detection data. In other words, the target monitored numerical value of the same type as the type of the first monitored data refers to the target monitored numerical value corresponding to the first monitored data.

For example, the first monitored data are the data of the temperature of the ambient environment, and the target monitored numerical value is the target temperature value that the user desires to reach.

S202: determining a triggering condition that the first monitored data and the target monitored numerical value satisfy, and determining a first action resource containing the triggering condition.

S203: determining an execution instruction in the first action resource, and sending the execution instruction to a first smart device corresponding to the first action resource.

S204: according to the first monitored data, monitoring a first execution effect corresponding to the first action resource, and according to a monitoring result of the first execution effect, starting up a second smart device related to the first smart device or shutting down the first smart device; and/or, according to the first monitored data, solving the conflict between the later-triggered second action resource and the first action resource.

In an embodiment of the present disclosure, the first action resource contains an identifier of the first smart device, a triggering condition of the first smart device, an execution instruction of the first smart device, a first action-effect resource setting forth the first execution effect of the first action resource and so on, and the first action-effect resource contains an identifier of a related second smart device. The monitoring on the execution effect of the first smart device corresponding to the first action resource is introduced, and, according to the monitoring result of the execution effect, the first smart device or the related second smart device is controlled, or the conflict between the action resources is eliminated, which is equivalent to realizing the combined controlling of a smart device based on the execution effect of the action resources.

The description will be made below by taking the smart gateway as an example.

Before the performance of the above steps, it is required to perform device registration. The method of registering the sensor, the smart device and the terminal device according to the embodiments of the present disclosure will be introduced below. The creating method and the contents of the action resources, and the method for controlling a smart device based on an action resource will be further introduced.

For example, the method of registering the sensor, the smart device and the terminal device comprises:

each of the sensors sending a registration request containing the identifier of this sensor to the smart gateway; each of the smart devices sending a registration request containing the identifier of this smart device to the smart gateway; and each of the terminal devices sending a registration request containing the identifier of this terminal device to the smart gateway. In other words, the sensor, the smart device and the terminal device individually send a registration request to the smart gateway, wherein the registration request contains the identifier information of itself.

The method further comprises: the smart gateway, after receiving the registration requests, parsing from the registration requests the identifiers of the sensors, the identifiers of the smart devices and the identifiers of the terminal devices, and storing the identifiers of the sensors, the identifiers of the smart devices and the identifiers of the terminal devices correspondingly under the identification names of this smart gateway. That is equivalent to establishing the subordination relation between the identifiers of the sensors and the identifier of this smart gateway, establishing the subordination relation between the identifiers of the smart devices and the identifier of this smart gateway, and establishing the subordination relation between the identifiers of the terminal devices and the identifier of this smart gateway, whereby, by the subordination of all of them to the identifier of this smart gateway, the association relation between the identifiers of the sensors, the identifiers of the smart devices and the identifiers of the terminal devices is established (i.e., binding).

The device identifier may serve as the unique identity identifier of the devices in the system. For example, the identifier of the sensor and the identifier of the smart device contain a unique identification code. For example, the unique identification code of the smart device may be a UUID (Universally Unique Identifier) or a MAC (Media Access Control) address. The identifier of the sensor and the identifier of the smart device may further contain at least one of the following: installation-position information, a device type, a device model, manufacturer information, a date of production, and so on.

For example, the identifier of the terminal device may contain: the unique identification code and/or the IMEI (International Mobile Equipment Identity) communication number and so on of this terminal device. For example, if the terminal device is provided with a mobile communication card or a device that can store a communication number, for example, an SIM (Subscriber Identity Module) card, a nano-SIM card or a micro-SIM card and so on, the identifier of the terminal device may further contain a communication number.

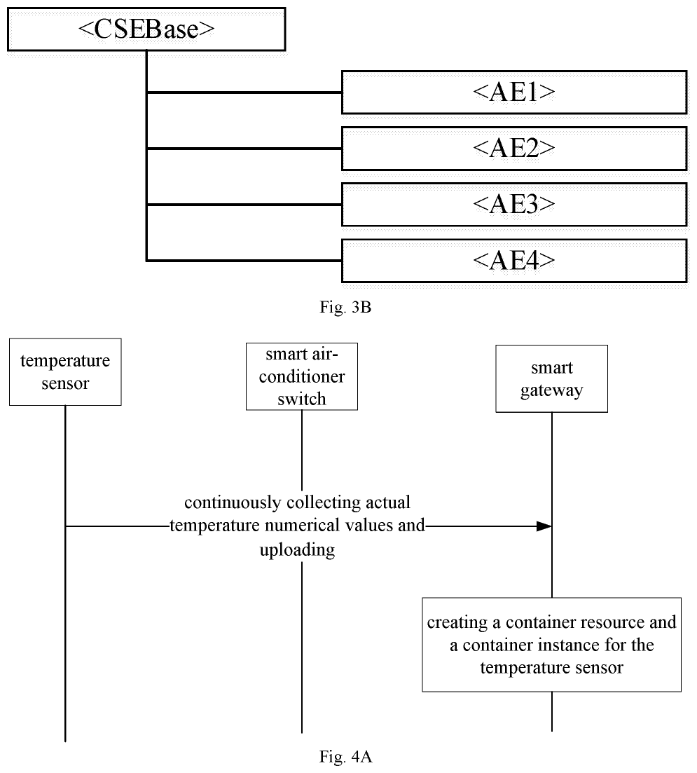

The method of registering the devices according to an embodiment of the present disclosure will be introduced by taking an example, and a schematic signaling diagram of the method is shown in FIG. 3A, comprising: a temperature sensor sending a registration request containing the identifier of this temperature sensor to the smart gateway (the identifier of the smart gateway is CSE); a smart air-conditioner switch sending a registration request containing the identifier of this smart air-conditioner switch to the smart gateway; a smart refrigerating-fan switch sending a registration request containing the identifier of this smart refrigerating-fan switch to the smart gateway; and a mobile phone sending a registration request containing the identifier of this mobile phone to the smart gateway.

As shown in FIG. 3B, the smart gateway, after receiving the registration requests, parses from the registration requests the identifier of the temperature sensor, the identifier of the smart air-conditioner switch, the identifier of the smart refrigerating-fan switch and the identifier of the mobile phone; creates a temperature-sensor resource AE1 according to the identifier of the temperature sensor, creates a smart-air-conditioner-switch resource AE2 according to the identifier of the smart air-conditioner switch, creates a smart-refrigerating-fan-switch resource AE4 according to the identifier of the smart refrigerating-fan switch, creates a mobile-phone resource AE3 according to the identifier of the mobile phone, and stores the respective identifiers in the respective resources; and creates a smart-gateway-base resource CSEBase, and uses all of the temperature-sensor resource AE1, the smart-air-conditioner-switch resource AE2, the smart-refrigerating-fan-switch resource AE4 and the mobile-phone resource AE3 as subordinate resources of the smart-gateway-base resource CSEBase to establish the association relation with the smart-gateway-base resource CSEBase. In other words, the temperature-sensor resource AE1, the smart-air-conditioner-switch resource AE2, the smart-refrigerating-fan-switch resource AE4 and the mobile-phone resource AE3 are associated together (i.e., binding) via the smart-gateway-base resource CSEBase.

The creating method of the action resources and the contents of the action resources according to the embodiments of the present disclosure will be introduced below.

The smart gateway may create N action resources, for example, a first action resource action1 to an N-th action resource actionN, wherein N is a positive integer.

The action (action) resources contain action-resource parameters and action effect (actionDesiredEffect) resources.

The action-resource parameters include the triggering condition, the execution instruction, the execution object and so on of the action resource.

The action-effect resource contains at least one of the following items: an effect resource identifier effectResourceID, an starting effect numerical value effectInitialValue, an current effect numerical value effectCurrentValue, an target effect numerical value effect Target Value, an effect monitoring period effectMornitorPeriod, an effect-predicted-reached period effectPredictedTime, a non-linear-effect parameter nonLinearParameter, an effect controlling parameter effectControlParameter, an effect controlling trend effectControlStatus, a related-device-involving switch relatedDeviceInvolved (or referred to as a related-action-involving switch relatedActionInvolved), a related-device-involving list relatedDeviceList (or referred to as a related-action-involving list relatedActionList), a related-device-involving setting relatedDeviceOption (or referred to as a related-action-involving setting relatedActionOption), a reverse-action switch relatedReverseActionInvolved, and a functioning duration effectTime. The reverse action according to the present disclosure refers to an operation opposite to the operation corresponding to the execution instruction.

For example, the action resource may further contain a checking (dependency) resource.

In an embodiment of the present disclosure, the smart gateway, for creating the action resources, may, according to experimentation data, empirical data, historical operation data and/or user-inputted data, configure various contents of the action resources, and generate the action resources. For example, the action resources may be created and generated simultaneously, and may also be created and generated at intervals, wherein the interval duration is not limited, and may, for example, be minutes, hours, days, weeks, months or years and so on. The present disclosure supports to continuously add or update the action resources.

For example, in an embodiment of the present disclosure, the action-effect resource is stored as a sub-resource of the action resource, or is stored as a parameter of the action resource; and the triggering condition is stored as a parameter of the action resource.

For example, in an embodiment of the present disclosure, the checking resource is stored as a sub-resource of the action resource.

The action resources and their parameters and sub-resources will be illustratively introduced below with reference to the drawings.

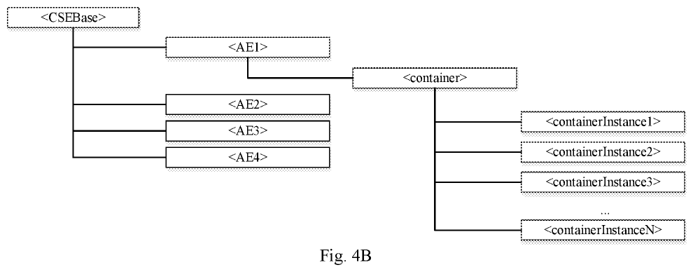

As shown in FIGS. 4A and 4B, a temperature sensor installed in a parlour continuously collects the actual-temperature numerical values of the parlour and continuously provides the temperature numerical values to a smart gateway. The smart gateway, after receiving the first actual parlour temperature numerical value, creates a container resource under the identification name of the temperature sensor, and creates N container instances containerinstance under the container resource, for example, containerinstance1 to containerinstanceN, wherein N is a positive integer. The smart gateway stores N real-time actual parlour temperature numerical values continuously received individually into the N container instances. For example, when the actual parlour temperature numerical values exceed N, the container instances are covering-stored; for example, the (N+i)-th actual parlour temperature numerical value is covering-stored into the i-th container instance, wherein i is a positive integer not greater than N.

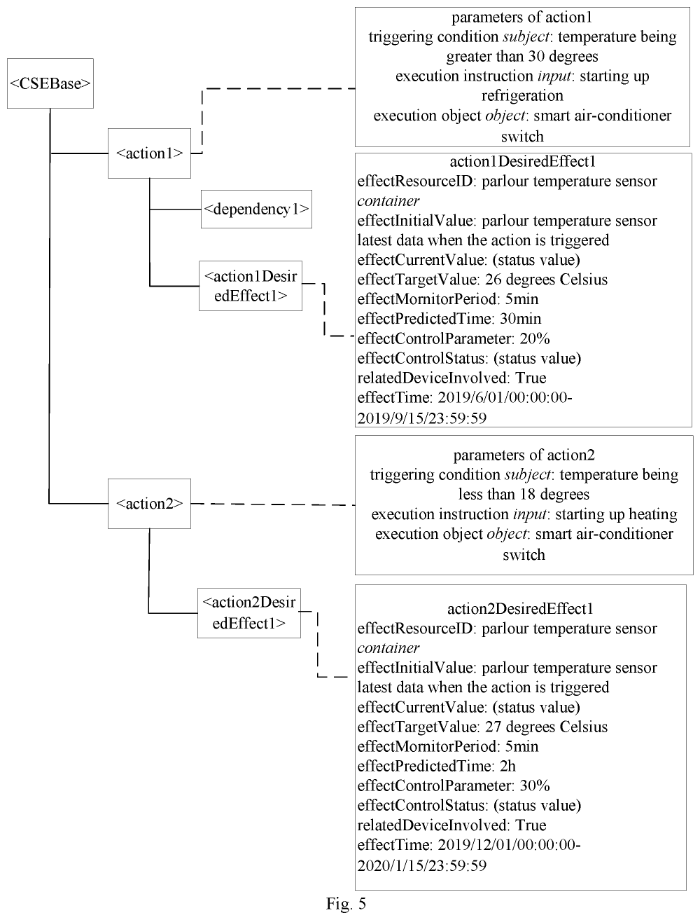

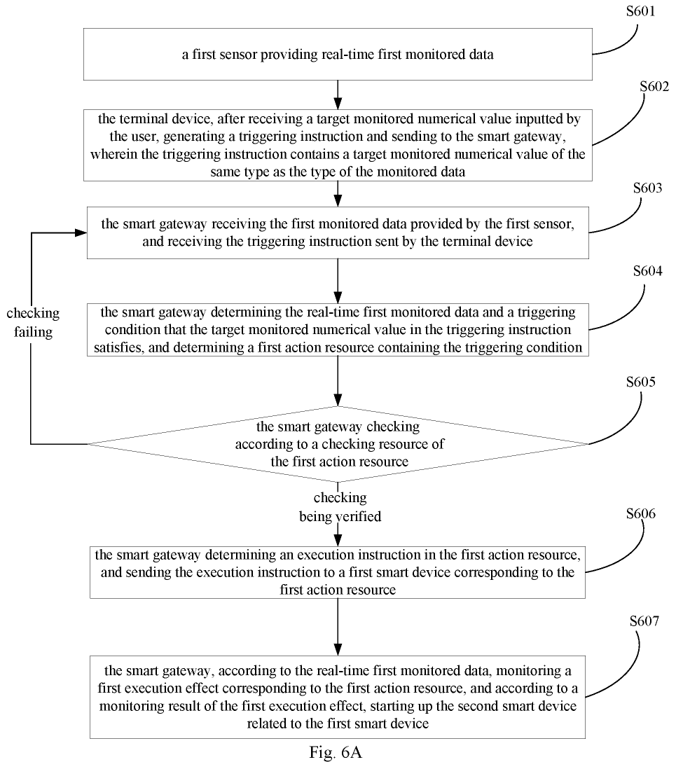

As shown in FIG. 5, the smart gateway creates a first action resource action1 and a second action resource action2.

The first action resource action1 contains a first checking resource dependency1 (which may also be referred to as first checking information) and a first action-effect resource action1DesiredEffect1 (which may also be referred to as first action-effect information).

The parameters of the first action resource action1 include a triggering condition subject, an execution instruction input and an execution object object. The triggering condition subject, the execution instruction input and the execution object object are set to be a temperature greater than 30 degrees, starting up the refrigeration, and a smart air-conditioner switch respectively.

The first action-effect resource action1DesiredEffect1 of the first action resource action1 contains the following parameters: an effect resource identifier effectResourceID, an starting effect numerical value effectInitialValue, an current effect numerical value effectCurrentValue, an target effect numerical value effectTargetValue, an effect monitoring period effectMornitorPeriod, an effect-predicted-reached period effectPredictedTime, an effect controlling parameter effectControlParameter, an effect controlling trend effectControlStatus, a related-device-involving switch relatedDeviceInvolved and a functioning duration effectTime.

For example, the status value of the effect resource identifier effectResourceID refers to the unique identifier of an action-effect resource for distinguishing it from other action-effect resources. The status value of the starting effect numerical value effectInitialValue refers to the monitored data at a starting moment in the state of monitoring the execution effect corresponding to the action-effect resource. The status value of the current effect numerical value effectCurrentValue refers to the real-time monitored data at the current moment in the state of monitoring the execution effect corresponding to the action-effect resource. The status value of the target effect numerical value effectTargetValue refers to the target monitored numerical value in a touch-controlling instruction. The status value of the effect monitoring period effectMornitorPeriod refers to the total monitoring duration of the execution effect corresponding to the action-effect resource.

The status value of the effect-predicted-reached period effectPredictedTime refers to the duration of each of the monitoring periods in the total monitoring duration, wherein the total monitoring duration comprises at least one monitoring period.

The status value of the effect controlling parameter effectControlParameter refers to an adjustable parameter numerical value.

The status value of the effect controlling trend effectControlStatus is under-control or out-of-control, and indicates whether, within the total monitoring duration, the different between the current effect numerical value and the target effect numerical value satisfies the controlled condition of the execution effect corresponding to the action-effect resource that they belong to.

The related-device-involving switch relatedDeviceInvolved indicates whether the second smart device related to the first smart device is required to be involved, if yes, then the status value of the related-device-involving switch is true True, and if no, then the status value of the related-device-involving switch is false False.

The status value of the functioning duration effectTime refers to the time period for which the execution effect corresponding to the action-effect resource is required to be monitored. If the current moment falls within the time period, then it is determined that it is required to monitor the execution effect corresponding to the action-effect resource. If the current moment does not fall within the time period, then it is determined that it is not required to monitor the execution effect corresponding to the action-effect resource.

The correspondingly set values of the above parameters in the first action-effect resource action1DesiredEffect1 of the first action resource action1 are individually: the parlour temperature sensor container (container), the parlour temperature sensor latest (latest) data when the action is triggered, the status value, 26 degrees Celsius, 5 min (minutes), 30 min, 20%, status value, true, and 2019/06/01/00:00:00-2019/09/15/23:59:59. The related contents of the status value of the current effect numerical value effectCurrentValue and the related contents of the status value of the effect controlling trend effectControlStatus will be described in detail below, and are not discussed here.

For example, the second action resource action2 contains a first action-effect resource action2DesiredEffect1 (also referred to as third action-effect information). The checking information is not provided. The parameters of the second action resource action2 include a triggering condition subject, an execution instruction input and an execution object object. The triggering condition subject, the execution instruction input and the execution object object are set to be a temperature less than 18 degrees, starting up the heating, and a smart air-conditioner switch respectively.

The first action-effect resource action2DesiredEffect1 of the second action resource action2 contains the following parameters: an effect resource identifier effectResourceID, an starting effect numerical value effectInitialValue, an current effect numerical value effectCurrentValue, an target effect numerical value effectTargetValue, an effect monitoring period effectMornitorPeriod, an effect-predicted-reached period effectPredictedTime, an effect controlling parameter effectControlParameter, an effect controlling trend effectControlStatus, a related-device-involving switch relatedDeviceInvolved and a functioning duration effectTime.

The correspondingly set values of the above parameters in the first action-effect resource action2DesiredEffect1 of the second action resource action2 are individually: the parlour temperature sensor container, the parlour temperature sensor latest data when the action is triggered, the status value, 27 degrees Celsius, 5 min, 2 h (hours), 20%, status value, true, and 2019/12/01/00:00:00-2020/01/15/23:59:59.

The method for controlling a smart device based on an action resource will be introduced below.

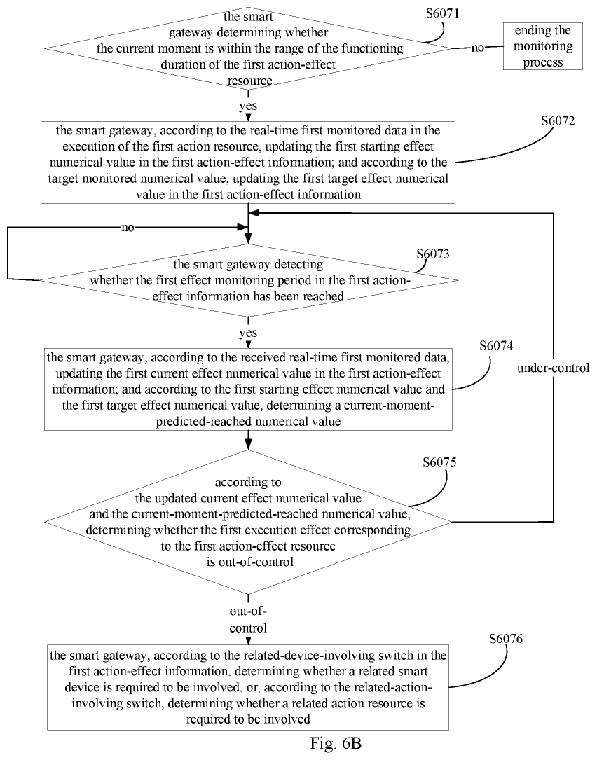

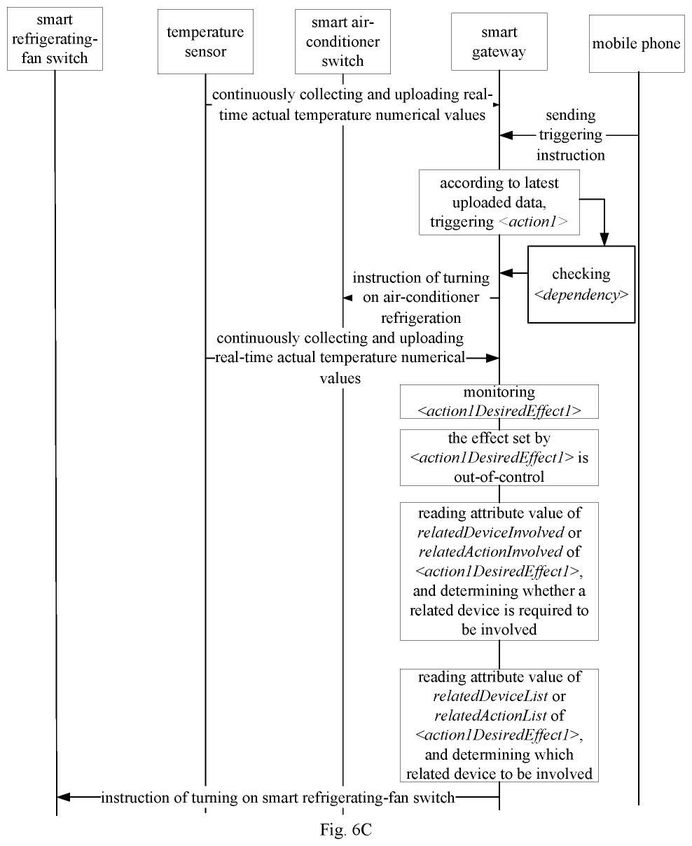

A schematic flow chart of the method for controlling a smart device based on an action resource is shown in FIG. 6A, which comprises the following steps S601-S607.

S601: a first sensor providing first monitored data.

The step S601 starts to be executed before S602, and continues till, after S607, a shutting-down instruction dispatched by the smart gateway has been received.

The first sensor may provide numerical values by using various modes. For example, a providing mode is to provide the collected numerical values in the form of time intervals. For example, another providing mode is to provide when the variation of the numerical values collected by the first sensor exceeds a preset threshold.

S602: the terminal device, after receiving a target monitored numerical value inputted by the user, generating a triggering instruction and sending to the smart gateway, wherein the triggering instruction contains a target monitored numerical value of the same type as the type of the monitored data.

For example, this step comprises: the terminal device, after receiving a target monitored numerical value inputted by the user, creating the triggering instruction, carrying the target monitored numerical value in the triggering instruction, and sending to the smart gateway the triggering instruction carrying the target monitored numerical value.

For example, this step comprises: the terminal device, after receiving a target temperature value inputted by the user, creating the triggering instruction, carrying the target temperature value in the triggering instruction, and sending to the smart gateway the triggering instruction carrying the target temperature value.

S603: the smart gateway receiving the first monitored data provided by the first sensor, and receiving the triggering instruction sent by the terminal device.

S604: the smart gateway determining the first monitored data and a triggering condition that the target monitored numerical value in the triggering instruction satisfies, and determining a first action resource containing the triggering condition.

S605: the smart gateway checking according to a first checking resource of the first action resource; if the checking fails, then jumping to the step S603; and if the checking is verified, executing the step S606.

For example, the step of the smart gateway checking according to a first checking resource of the first action resource comprises: determining whether an smart device having the effect opposite to that of the first smart device is being executed; if yes, then the checking failing, terminating sending the execution instruction to the first smart device corresponding to the first action resource, and ending the process or jumping to the step S603; and if the checking is verified, executing the step S606.

For example, the first smart device is a smart air conditioner, the smart device having the effect opposite is a smart window-magnetism device or a smart door-magnetism device, and, the step of, after the action resource of the smart air conditioner has been triggered, the smart gateway checking according to a checking resource of the action resource, comprises: determining whether the smart window-magnetism device or smart door-magnetism device having the effect opposite to that of the smart air conditioner is being executed; if yes, then that indicating that a window corresponding to the smart window-magnetism device has been opened or a door corresponding to the smart door-magnetism device has been opened, and the checking fails, and terminating sending the execution instruction to the smart air conditioner of the action resource, and ending the process or jumping to the step S603; and if the checking is verified, then executing the step S606.

S606: the smart gateway determining an execution instruction in the first action resource, and sending the execution instruction to a first smart device corresponding to the first action resource.

S607: the smart gateway, according to the real-time first monitored data, monitoring a first execution effect corresponding to the first action resource, and according to a monitoring result of the first execution effect, starting up the second smart device related to the first smart device.

For example, the execution effect corresponding to the action resource according to the present disclosure mainly includes: the degree of consistence between the real-time monitored data collected and provided by the sensor and the target monitored numerical value after the smart device corresponding to the action resource has executed the execution instruction in the action resource, for example, whether the real-time monitored data and the target monitored numerical value can satisfy the predetermined condition within a predetermined time period.

For example, if the real-time monitored data and the target monitored numerical value can satisfy the predetermined condition within a predetermined time period, then it is determined that the monitoring result according to the present disclosure is under-control, or else it is determined that the monitoring result is out-of-control.

For example, the step of, according to the real-time first monitored data, monitoring a first execution effect corresponding to the first action resource comprises: according to the real-time first monitored data in the execution of the first action resource, updating a first starting effect numerical value in a first action-effect resource corresponding to the first execution effect; according to the target monitored numerical value, updating a first target effect numerical value in the first action-effect resource; according to a first effect monitoring period in the first action-effect resource, receiving the first monitored data, and updating a first current effect numerical value in the first action-effect resource; according to the first starting effect numerical value and the first target effect numerical value, determining a current-moment-predicted-reached numerical value; according to the updated first current effect numerical value and the current-moment-predicted-reached numerical value, determining whether the first execution effect is out-of-control, and updating the determination result to the status value of a first effect controlling trend in the first action-effect resource; if the execution effect is under-control, then continuing detection in the next period; and if the first execution effect is out-of-control, then determining whether a related second smart device or a related action resource is required to be involved.

For example, after the step S607, the method comprises: the terminal device, after receiving the shutting-down instruction inputted by the user, providing the shutting-down instruction to the smart gateway; the smart gateway dispatching the shutting-down instruction to the related smart devices and sensors; and the related smart devices and sensors performing the shutting-down operation according to the shutting-down instruction.

For example, in the step S607, a schematic flow chart of the method of, according to the real-time first monitored data, monitoring a first execution effect corresponding to the first action resource is shown in FIG. 6B, which comprises the following steps:

S6071: the smart gateway determining whether the current moment is within the range of the functioning duration effectTime of the first action-effect resource of the first action resource; if yes, then executing the step S6072; and if no, ending the process of monitoring the first execution effect corresponding to the first action-effect resource.

In the present disclosure, after the first smart device has been started up according to the execution instruction, the real-time monitored data received by the corresponding sensor is stored as action-effect data, and updated into the first action-effect resource. At this point, the real-time monitored data are still stored or covering-stored into the container instance of the container resource of that sensor.

For example, if the action-effect data are stored as a parameter of the first action resource, then the action-effect data in the first action resource are directly accessed.

For example, if the first action-effect resource is stored in the first action resource as a sub-resource, then the action-effect data in the first action-effect resource in the first action resource are directly accessed.

For example, this step comprises: the smart gateway reading the functioning duration effectTime from the first action-effect resource of the first action resource; determining whether the current moment is within the range of the functioning duration of the first action resource; if yes, then executing the step S6072; and if no, ending the process of monitoring the first execution effect.

S6072: the smart gateway, according to the real-time first monitored data in the execution of the first action resource, updating the first starting effect numerical value effectInitialValue in the first action-effect resource; and according to the target monitored numerical value, updating the first target effect numerical value effect Target Value in the first action-effect resource.

S6073: the smart gateway, according to the first effect monitoring period effectMornitorPeriod in the first action-effect resource, monitoring whether the current effect monitoring period has been reached; if yes, then executing S6075; and if no, continuing executing this step.

S6074: the smart gateway, according to the received real-time first monitored data, updating the first current effect numerical value effectCurrentValue in the first action-effect resource; and according to the first starting effect numerical value and the first target effect numerical value, determining a current-moment-predicted-reached numerical value.

For example, the step of, according to the first starting effect numerical value and the first target effect numerical value, determining the current-moment-predicted-reached numerical value comprises: according to the first starting effect numerical value, the first target effect numerical value, the first effect-predicted-reached period and the first effect monitoring period, determining an each-time-interval-predicted-reached effect; and according to the time difference between the current moment and the initial moment, the first effect monitoring period and the each-time-interval-predicted-reached effect, determining a current-moment-predicted-reached numerical value, wherein the initial moment is the starting moment of the execution of the action resource.

For example, in order to facilitate the understanding and facilitate introduction by using formulas, the first starting effect numerical value effectInitialValue is set to be V0; the first current effect numerical value effectCurrentValue is set to be Vc; and the first target effect numerical value effect Target Value is set to be Vt.

The first effect monitoring period effectMornitorPeriod is set to be Δt; the first effect-predicted-reached period effectPredictedTime is set to be Tp (relative value); the initial time is set to be t0, wherein the initial time is the starting moment of the monitoring on the action effect; and the current time is set to be tc, wherein the current time is the current moment.

The each-time-interval-predicted-reached effect e=(Vt−V0)/(Tp/Δt).

The current-moment-predicted-reached numerical value V=int((tc−t0)/Δt)*e.

S6075: the smart gateway, according to the updated first current effect numerical value and the current-moment-predicted-reached numerical value, determining whether the first execution effect corresponding to the first action-effect resource is out-of-control, and updating the determination result to a first effect controlling trend effcetControlStatus in the first action-effect resource; if it is under-control, then continuing detection in the next period, and jumping to the step S6073; and if it is out-of-control, then executing S6076.

For example, the step of, according to the updated first current effect numerical value Vc and the current-moment-predicted-reached numerical value, determining whether the first execution effect is out-of-control comprises: according to the first effect controlling parameter effectControlParameter in the first action-effect resource, and the current-moment-predicted-reached numerical value, determining the upper limit of the current-moment-predicted-reached numerical value and the lower limit of the current-moment-predicted-reached numerical value; and according to the upper limit of the current-moment-predicted-reached numerical value, the lower limit of the current-moment-predicted-reached numerical value and the updated first current effect numerical value Vc, determining whether the first execution effect is out-of-control.

For example, the updated first current effect numerical value is Vc, and the first effect controlling parameter effectControlParameter is set to be ec, wherein the ec is a percentage type. The upper limit of the current-moment-predicted-reached numerical value is V*(1+ec), and the lower limit of the current-moment-predicted-reached numerical value is V*(1−ec). This step may comprise: determining whether Vc satisfies Vc<V*(1+ec) and Vc>V*(1−ec); if yes, then determining that the first execution effect is under-control, and updating the first effect controlling trend effcetControlStatus to be under-control underControl; and if no, determining that the first execution effect is out-of-control, and updating the first effect controlling trend effcetControlStatus to be out-of-control outOfControl.

For example, this step comprises: when the determination result or the first effect controlling trend is under-control, the smart gateway detecting whether the difference between the current moment and the starting moment of the monitoring reaches the first effect-predicted-reached period effectPredictedTime of the first action-effect resource; if yes, then ending the monitoring; and if no, continuing detection in a next period, and jumping to the step S6073.

S6076: the smart gateway, according to the related-device-involving switch relatedDeviceInvolved in the first action-effect resource, determining whether a related second smart device is required to be involved, or, according to the related-action-involving switch relatedActionInvolved, determining whether a related action resource is required to be involved.

For example, this step comprises: the smart gateway reading the status value of the related-device-involving switch relatedDeviceInvolved in the first action-effect resource; if the read status value is true, then a related device being required to be involved; and if the read status value is false, then a related device being not required to be involved.

Alternatively, this step comprises: the smart gateway reading the status value of the related-action-involving switch relatedActionInvolved; if the read status value is true, a related action resource being required to be involved; and if the read status value is false, a related action resource being not required to be involved.

For example, when the smart gateway has determined that a related second smart device is required to be involved, in S607, the step of, according to the monitoring result of the action effect, starting up the second smart device related to the first smart device comprises: the smart gateway operating according to the related-device-involving setting relatedDeviceOption or the related-action-involving setting relatedActionOption in the first action-effect resource of the action resource; reading the related-device-involving list relatedDeviceList or the related-action-involving list relatedActionList in the first action-effect resource, and selecting from them the identifier of one smart device as the identifier of the related second smart device; according to the identifier of the related second smart device, generating a starting-up instruction, and sending to the related second smart device; and the related second smart device performing the starting-up operation according to the received starting-up instruction.

An example of the method for controlling a smart device based on an action resource will be introduced below with reference to the drawings.

As shown in FIG. 6C, the method comprises: the temperature sensor continuously collecting real-time actual-temperature numerical values and continuously providing to the smart gateway, wherein the monitored data are, in the present example, for example, the actual-temperature numerical values;

the mobile phone sending to the smart gateway a triggering instruction containing a target monitored temperature;

the smart gateway, after receiving that triggering instruction, according to the lately provided actual-temperature numerical value, determining that the triggering condition of the first action resource action1 is satisfied, and the first action resource action1 is triggered;

the smart gateway checking the first action resource action1, and if the checking is verified, sending a refrigeration starting-up instruction to the smart air-conditioner switch;

the smart air-conditioner switch, according to the refrigeration starting-up instruction, starting up the air conditioner for the refrigeration;

the temperature sensor collecting and providing a real-time actual-temperature numerical value as the current effect numerical value;

the smart gateway, according to the first current effect numerical value, updating the first action-effect resource action1DesiredEffect1 of the first action resource action1, and monitoring the first action-effect resource action1DesiredEffect1 of the first action resource action1; when the action effect of the first action-effect resource action1DesiredEffect1 is out-of-control, reading the status value of the related-device-involving switch relatedDeviceInvolved or the related-action-involving switch relatedActionInvolved of the first action-effect resource action1DesiredEffect1, and, according to the read status value, determining whether a related second smart device is required to be involved; and when it is determined that a related second smart device is required to be involved, reading the attribute value of the related-device-involving list relatedDeviceList or the related-action-involving list relatedActionList in the action-effect resource, selecting a related smart refrigerating-fan switch according to the attribute value, and sending the refrigeration triggering instruction to the related smart refrigerating-fan switch; and

the smart refrigerating-fan switch, according to the received refrigeration triggering instruction, starting up a refrigerating fan or a smart refrigerating fan for the refrigeration.

In the embodiment of the present disclosure, the first action resource contains an identifier of the first smart device, a triggering condition of the first smart device, an execution instruction of the first smart device, a first action-effect resource setting forth the first execution effect of the first action resource and so on, and the first action-effect resource contains the identifier of the second smart device related to the first smart device. The monitoring on the execution effect of the first smart device corresponding to the first action resource is introduced, and when the monitoring result of the execution effect is out-of-control, that indicates that the operation of the mere first smart device cannot reach the predetermined target monitored numerical value within the predetermined duration. Therefore the related second smart device having the same function (for example, refrigeration) is controlled to be started up, to jointly operate with the first smart device, which is equivalent to realizing the combined controlling of a smart device based on the action effect, whereby, as compared with the conventional modes in which each of the smart devices is separately controlled and the action effects frequently have a conflict therebetween, the controlling is more accurate and has a higher efficiency.

Another method for controlling a smart device based on an action resource will be introduced below, wherein the differences from the above-described method for controlling a smart device based on an action resource will be introduced emphatically, and the same points will be omitted to the greatest extent.

For example, in the step S203, after the step of determining an execution instruction in the first action resource, and sending the execution instruction to a first smart device corresponding to the first action resource, the method further comprises: receiving second monitored data provided by a second sensor; according to the real-time first monitored data, monitoring an execution effect of the first action resource, and, according to the monitoring result of the execution effect, shutting down the first smart device, comprising: according to the real-time second monitored data, monitoring a second execution effect corresponding to the first action resource, and updating the second action-effect information (which may also be referred to as the second action-effect resource) of the first action resource corresponding to the second execution effect; and when the monitoring result of the second execution effect is out-of-control, determining that it is required to shut down the first smart device, and executing an operation instruction opposite to the execution instruction.

In some embodiments, the second sensor may provide numerical values by using various modes. For example, a providing mode is to provide the collected numerical values in the form of time intervals. For example, another providing mode is to provide when the variation of the numerical values collected by the second sensor exceeds a preset threshold.

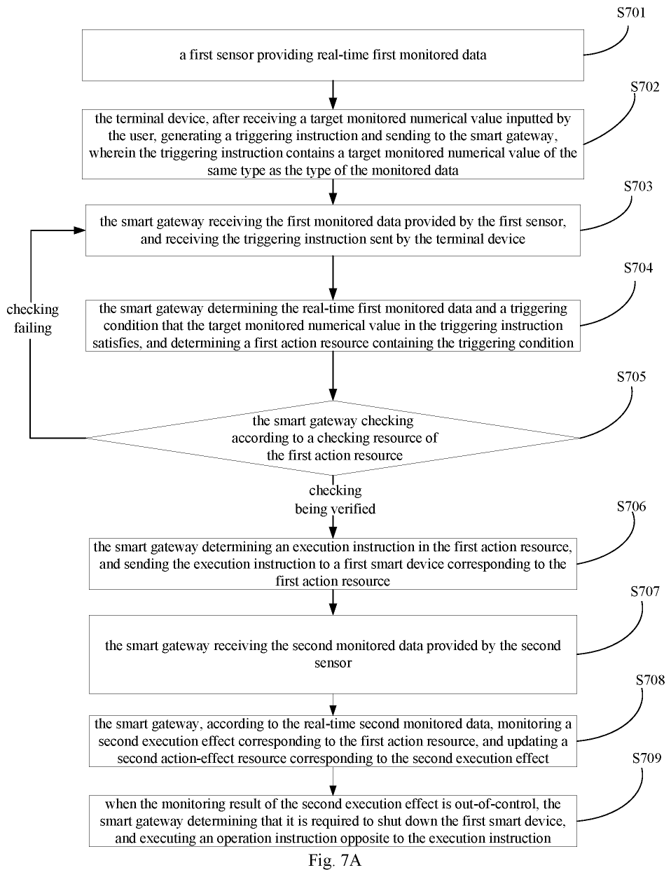

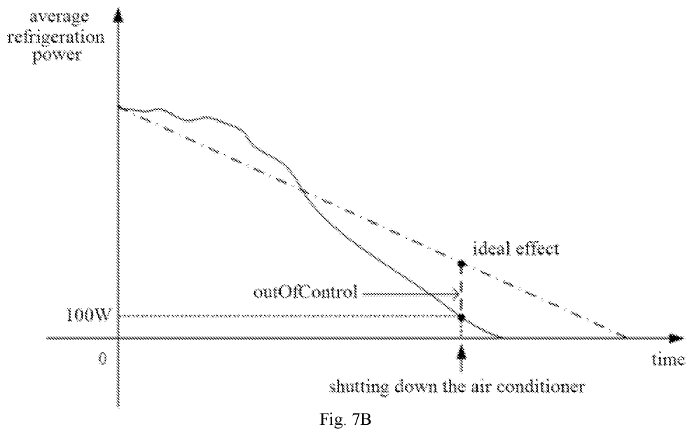

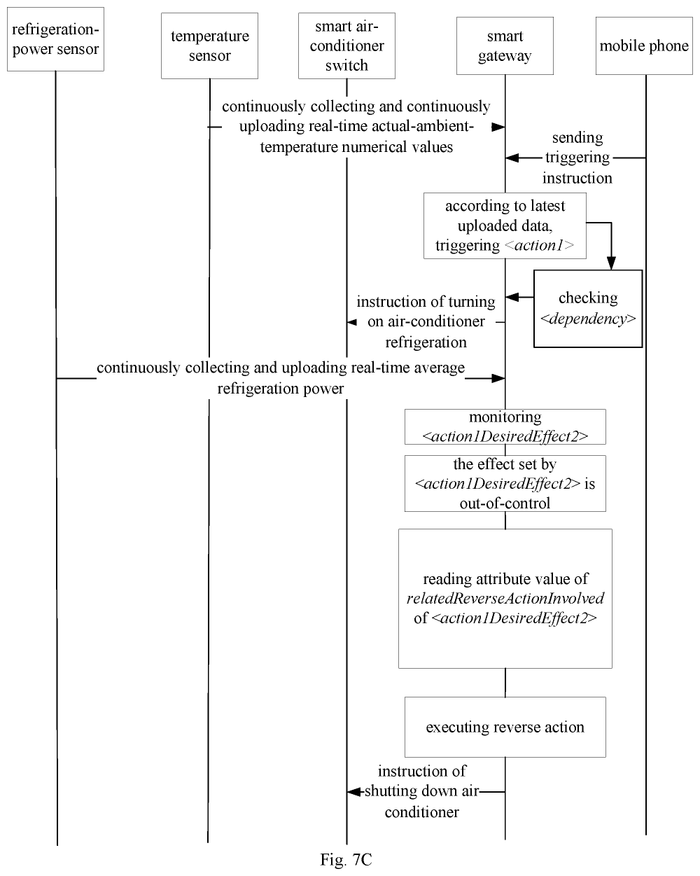

For example, a schematic flow chart of another method for controlling a smart device based on an action resource is shown in FIG. 7A, which comprises the following steps S701-S709: S701: a first sensor providing real-time first monitored data.

For example, the method of S701 is the same as the method of S601, and is not discussed further.

The step S701 starts to be executed before S702, and continues till, after S709, a shutting-down instruction dispatched by the smart gateway has been received.

S702: the terminal device, after receiving a target monitored numerical value inputted by the user, generating a triggering instruction and sending to the smart gateway, wherein the triggering instruction contains a target monitored numerical value of the same type as the type of the monitored data.

For example, the method of S702 is the same as the method of S602, and is not discussed further.

S703: the smart gateway receiving the first monitored data provided by the first sensor, and receiving the triggering instruction sent by the terminal device.

For example, the method of S703 is the same as the method of S603, and is not discussed further.

S704: the smart gateway determining the real-time first monitored data and a triggering condition that the target monitored numerical value in the triggering instruction satisfies, and determining the first action resource that the triggering condition belongs to.

For example, the method of S704 is the same as the method of S604, and is not discussed further.

S705: the smart gateway checking according to a first checking resource of the first action resource; if the checking fails, then jumping to the step S703; and if the checking is verified, then executing the step S706.

For example, the step of the smart gateway checking according to a first checking resource of the first action resource comprises: determining whether an smart device having the effect opposite to that of the first smart device is being executed, if yes, then the checking failing, terminating sending the execution instruction to the first smart device corresponding to the first action resource, and ending the process or jumping to the step S703; and if the checking is verified, then executing the step S706.

For example, the method of S705 is the same as the method of S605, and is not discussed further.

S706: the smart gateway determining an execution instruction in the first action resource, and sending the execution instruction to a first smart device corresponding to the first action resource.

For example, the method of S706 is the same as the method of S606, and is not discussed further.

For example, a sensor is the temperature sensor of a parlour, and the first action-effect resource action1DesiredEffect1 of the first action resource action1 contains the following parameters: an effect resource identifier effectResourceID, an starting effect numerical value effectInitialValue, an current effect numerical value effectCurrentValue, an target effect numerical value effect Target Value, an effect monitoring period effectMornitorPeriod, an effect-predicted-reached period effectPredictedTime, an effect controlling parameter effectControlParameter, an effect controlling trend effectControlStatus, a related-device-involving switch relatedDeviceInvolved and a functioning duration effectTime.

The correspondingly set values of the above parameters in the first action-effect resource action1DesiredEffect1 of the first action resource action1 are individually: the parlour temperature sensor container (container), the parlour temperature sensor latest (latest) data when the action is triggered, the status value, 26 degrees Celsius, 5 min (minutes), 30 min, 20%, status value, true, and 2019/06/01/00:00:00-2019/09/15/23:59:59.

For example, this step comprises: the smart gateway determining an execution instruction in the first action resource, and sending the execution instruction to the first smart device corresponding to the first action resource, and the first smart device being started up in response to receiving the execution instruction.

After the first smart device has been started up, the real-time actual-temperature numerical values that the parlour temperature sensor continuously collects and provides are actually stored as the current effect numerical value in the action-effect data. Therefore, according to the real-time actual-temperature numerical values that the parlour temperature sensor continuously collects and provides, the status value of the current effect numerical value effectCurrentValue is updated.

S707: the smart gateway receiving the second monitored data provided by the second sensor.

For example, the second sensor may be an average-refrigeration-power sensor. The first action resource action1 further contains a second action-effect resource action1DesiredEffect2 (which may also be referred to as second action-effect information), and the second action-effect resource action1DesiredEffect2 of the first action resource action1 contains the following parameters: an effect resource identifier effectResourceID, an starting effect numerical value effectInitialValue, an current effect numerical value effectCurrentValue, an target effect numerical value effect Target Value, an effect monitoring period effectMornitorPeriod, an effect-predicted-reached period effectPredictedTime, an effect controlling parameter effectControlParameter, an effect controlling trend effectControlStatus, a related-device-involving switch relatedDeviceInvolved and a functioning duration effectTime.

The correspondingly set values of the above parameters in the second action-effect resource action1DesiredEffect2 of the first action resource action1 are individually: the average-refrigeration-power sensor container (container), the parlour temperature sensor latest (latest) data when the action is triggered, the status value, 100 W (watts), 5 min, 12 h, 50%, status value, true, and 2019/06/01/00:00:00-2019/09/15/23:59:59.

S708: the smart gateway, according to the real-time second monitored data, monitoring a second execution effect corresponding to the first action resource, and updating the second action-effect resource of the first action resource corresponding to the second execution effect.

For example, the method of S708 is the same as the method of the step S607 of, according to the real-time first monitored data, monitoring the first execution effect, wherein the second monitored data replace the first monitored data, or, in S708, it is required to monitor the first execution effect and the second execution effect corresponding to the first monitored data and the second monitored data, and is not discussed further.

S709: when the monitoring result of the second execution effect is out-of-control, the smart gateway determining to shut down the first smart device, and executing an operation instruction opposite to the execution instruction.

For example, this step comprises: when the monitoring result of the second execution effect corresponding to the second action-effect resource is out-of-control, the smart gateway determining that it is required to execute a reverse action to the first smart device, wherein the reverse action refers to an operation opposite to the operation corresponding to the execution instruction, and sending to the first smart device the operation instruction opposite to the execution instruction; and the first smart device, according to the received operation instruction opposite to the execution instruction, performing the shutting-down operation.

For example, when the monitoring result of the average refrigeration power of the second execution effect, after the smart air-conditioner switch has started up the air conditioner for the refrigeration, is out-of-control, that indicates that the refrigeration has already reached the preset target-temperature numerical value (as the target effect numerical value), and, as shown in FIG. 7B, the average refrigeration power of the air conditioner has already been low, and is far less than the ideal effect. Therefore, the difference between the average refrigeration power of the ideal effect and the current actual average refrigeration power has already exceeded the controlled range represented by the dotted horizontal line, i.e., out of control, which indicates that the smart air-conditioner switch and the air conditioner have already completed the task of refrigeration, and can be shut down temporarily.

For example, this step comprises: when the monitoring result of the first execution effect corresponding to the first action-effect resource is under-control, and the monitoring result of the second execution effect corresponding to the second action-effect resource is out-of-control, the smart gateway determining that it is required to execute a reverse action to the first smart device, and sending to the first smart device the operation instruction opposite to the execution instruction; and the first smart device, according to the received operation instruction opposite to the execution instruction, performing the shutting-down operation.

For example, after the first action resource is executed to cause the smart air-conditioner switch to start up the air conditioner for refrigeration, when the monitoring result of the first execution effect related to the temperature is under-control, and the monitoring result of the second execution effect related to the average refrigeration power is out-of-control, that indicates that the refrigeration has already reached the preset target-temperature numerical value (as the target effect numerical value), and, as shown in FIG. 7B, the average refrigeration power of the air conditioner has already been low, and is far less than the ideal effect. Therefore, the difference between the average refrigeration power of the ideal effect and the current actual average refrigeration power has already exceeded the controlled range represented by the dotted horizontal line, i.e., out of control, which indicates that the smart air-conditioner switch and the air conditioner have already completed the task of refrigeration, and can be shut down temporarily. Alternatively, that indicates that, as the related second smart device has been started up and is operating, the task of refrigeration has already been completed, and the smart air-conditioner switch and the air conditioner can be shut down temporarily.

An example of another method for controlling a smart device based on an action resource will be introduced below with reference to the drawings.

As shown in FIG. 7C, the method comprises: the temperature sensor continuously collecting real-time actual-temperature numerical values and continuously providing to the smart gateway, wherein the monitored data are, in the present example, the actual-temperature numerical values;

the mobile phone sending to the smart gateway a triggering instruction containing a target temperature;

the smart gateway, after receiving that triggering instruction, according to the lately provided actual-temperature numerical value, determining that the triggering condition of the first action resource action1 is satisfied, and the first action resource action1 being triggered;

the smart gateway checking the first action resource, and if the checking is verified, sending a refrigeration starting-up instruction to the smart air-conditioner switch;

the smart air-conditioner switch, according to the refrigeration starting-up instruction, starting up the air conditioner for the refrigeration;

the temperature sensor continuing collecting and providing a real-time actual-temperature numerical value;

the refrigeration-power sensor starting to operate, and continuously collecting and providing real-time average-refrigeration-power numerical values;

the smart gateway, after receiving the average-refrigeration-power numerical values, determining to trigger the monitoring on the second execution effect corresponding to the second action-effect resource of the first action resource;

the smart gateway using the received real-time average-refrigeration-power numerical value as the current effect numerical value, updating the second action-effect resource action1DesiredEffect2 of the first action resource according to the current effect numerical value, and monitoring the second execution effect corresponding to the second action-effect resource; and when the second execution effect corresponding to the second action-effect resource is out-of-control, reading the attribute value of the related reverse-action switch relatedReverseActionInvolved of the second action-effect resource, executing the reverse action of the smart air-conditioner switch (i.e., shutting down) according to the attribute value, and sending a refrigeration shutting-down instruction to the smart air-conditioner switch; and

the smart air-conditioner switch, according to the received refrigeration shutting-down instruction, shutting down the refrigeration function of the air conditioner, for example, directly shutting down the entire air conditioner.

In the embodiment of the present disclosure, the first action resource contains an identifier of the first smart device, a triggering condition of the first smart device, an execution instruction of the first smart device, a first action-effect resource setting forth the first execution effect of the first action resource and so on, and the first action-effect resource contains an identifier of a related second smart device. The monitoring on the execution effect corresponding to the two action-effect resources of the first smart device corresponding to the first action resource is introduced, and when the monitoring result of the second execution effect corresponding to the second action-effect resource is out-of-control, that indicates that the first smart device has reached the preset target monitored numerical value. Therefore, the first smart device can be controlled to be shut down temporarily, whereby the controlling is more accurate and has a higher efficiency, thereby facilitating energy saving.

Yet another method for controlling a smart device based on an action resource will be introduced below, wherein the differences from the above-described method for controlling a smart device based on an action resource will be introduced emphatically, and the same points will be omitted to the greatest extent.

For example, in the step S204, the step of, according to the first monitored data, solving the conflict between the later-triggered second action resource and the first action resource comprises: when the real-time first monitored data provided by the first sensor trigger a second action resource, determining a functioning duration in the second action resource and a functioning duration in the first action resource; when the functioning duration in the first action resource contains the current moment, continuing executing the first action resource, and ignoring the second action resource; and when the functioning duration in the second action resource contains the current moment, executing the second action resource, and terminating executing the first action resource.

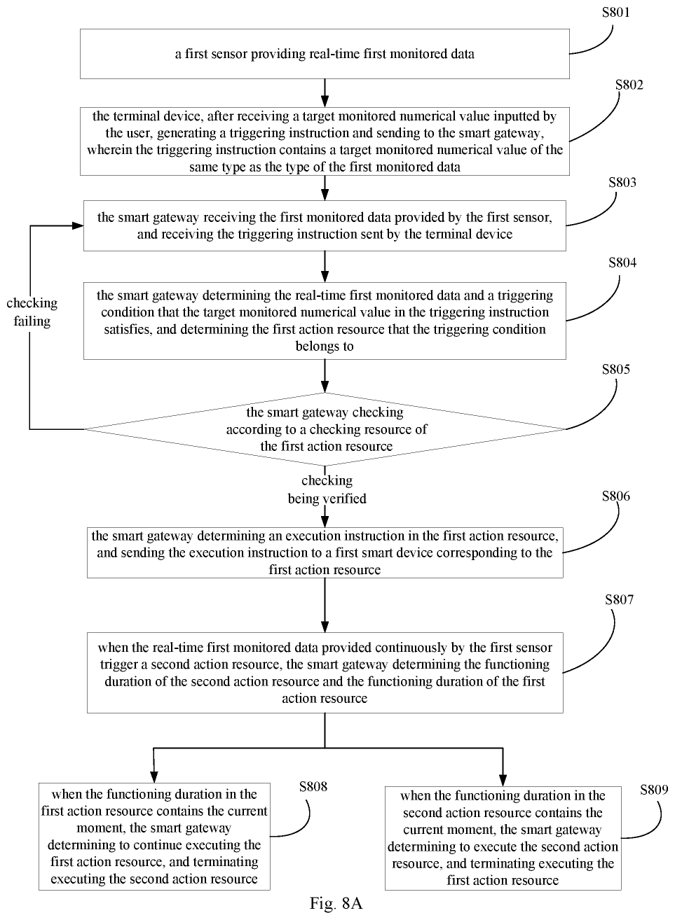

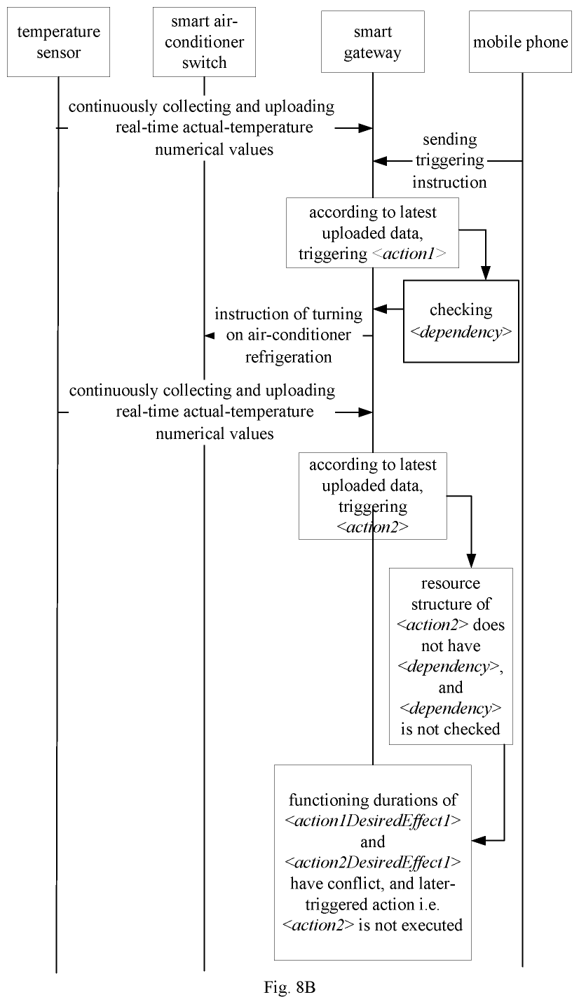

For example, a schematic flow chart of yet another method for controlling a smart device based on an action resource is shown in FIG. 8A, which comprises the following steps S801-S809.

S801: a first sensor providing real-time first monitored data.

For example, the method of S801 is the same as the method of S601, and is not discussed further.

The step S801 starts to be executed before S802, and continues till, after S809, a shutting-down instruction dispatched by the smart gateway has been received.

S802: the terminal device, after receiving a target monitored numerical value inputted by the user, generating a triggering instruction and sending to the smart gateway, wherein the triggering instruction contains a target monitored numerical value of the same type as the type of the monitored data.

For example, the method of S802 is the same as the method of S602, and is not discussed further.

S803: the smart gateway receiving the first monitored data provided by the first sensor, and receiving the triggering instruction sent by the terminal device.

For example, the method of S803 is the same as the method of S603, and is not discussed further.

S804: the smart gateway determining the real-time first monitored data and a triggering condition that the target monitored numerical value in the triggering instruction satisfies, and determining a first action resource containing the triggering condition.

For example, the method of S804 is the same as the method of S604, and is not discussed further.

S805: the smart gateway checking according to a first checking resource of the first action resource; if the checking fails, then jumping to the step S803; and if the checking is verified, then executing the step S806.

For example, the step of the smart gateway checking according to a first checking resource of the first action resource comprises: determining whether an smart device having the effect opposite to that of the first smart device is being executed, if yes, then the checking failing, terminating sending the execution instruction to the first smart device corresponding to the first action resource, and ending the process or jumping to the step S803; and if the checking is verified, then executing the step S806.

For example, the method of S805 is the same as the method of S605, and is not discussed further.

S806: the smart gateway determining an execution instruction in the first action resource, and sending the execution instruction to a first smart device corresponding to the first action resource.

For example, the method of S706 is the same as the method of S606, and is not discussed further.

For example, the first sensor is the temperature sensor of a parlour, and the parameters of the first action resource include a triggering condition subject, an execution instruction input and an execution object object. The triggering condition subject, the execution instruction input and the execution object object are set to be a temperature greater than 30 degrees, starting up the refrigeration, and a smart air-conditioner switch respectively. The first action-effect resource action1DesiredEffect1 of the first action resource action1 contains the following parameters: a functioning duration effectTime. The correspondingly set value of the functioning duration effectTime is: 2019/06/01/00:00:00-2019/09/15/23:59:59.

For example, this step comprises: the smart gateway determining an execution instruction in the first action resource, and sending the execution instruction to the first smart device corresponding to the first action resource, and the first smart device being started up in response to receiving the execution instruction.

S807: when the real-time first monitored data provided by the first sensor trigger a second action resource, the smart gateway determining a functioning duration in the second action resource and a functioning duration in the first action resource, and subsequently executing S808 or S809.

For example, after the first smart device has been started up in the above step, this step starts, and this step comprises the parlour temperature sensor continuing continuously collecting and providing the real-time actual-temperature numerical values, triggering the second action resource action2, and determining the functioning duration in the first action-effect resource action2DesiredEffect1 of the second action resource action2, and the functioning duration in the first action-effect resource action1DesiredEffect1 of the first action resource action1.

For example, the second action resource action2 contains the first action-effect resource action2DesiredEffect1, and the checking resource is not provided. The parameters of the second action resource action2 include a triggering condition subject, an execution instruction input and an execution object object. The triggering condition subject, the execution instruction input and the execution object object are set to be a temperature less than 18 degrees, starting up the heating, and a smart air-conditioner switch respectively. The first action-effect resource action2DesiredEffect1 of the second action resource action2 contains the following parameters: a functioning duration effectTime. The correspondingly set value of the functioning duration effectTime is: 2019/12/01/00:00:00-2020/01/15/23:59:59.

S808: when the functioning duration in the first action resource contains the current moment, the smart gateway determining to continue executing the first action resource, and ignoring the second action resource.

For example, this step comprises: the smart gateway acquiring the current moment; and when it is determined that the current moment falls within the functioning duration in the first action-effect resource of the first action resource, and does not fall within the functioning duration in the first action-effect resource of the second action resource, determining to continue executing the first action resource, and ignoring the second action resource.

S809: when the functioning duration in the second action resource contains the current moment, the smart gateway determining to execute the second action resource, and terminating executing the first action resource.

For example, this step comprises: the smart gateway acquiring the current moment; and when it is determined that the current moment falls within the functioning duration in the first action-effect resource of the second action resource, and does not fall within the functioning duration in the first action-effect resource of the first action resource, determining to execute the second action resource, and terminating executing the first action resource.

An example of yet another method for controlling a smart device based on an action resource will be introduced below with reference to the drawings.

As shown in FIG. 8B, the method comprises: the temperature sensor continuously collecting real-time monitored temperature numerical values and continuously providing to the smart gateway;

the mobile phone sending to the smart gateway a triggering instruction containing a target monitored temperature;

the smart gateway, after receiving that triggering instruction, according to the lately provided real-time actual-temperature numerical value, determining that the triggering condition of the first action resource action1 is satisfied, and the first action resource action1 being triggered;

the smart gateway checking the first action resource action1, and if the checking is verified, sending a refrigeration starting-up instruction to the smart air-conditioner switch;

the smart air-conditioner switch, according to the refrigeration starting-up instruction, starting up the air conditioner for the refrigeration;

the temperature sensor subsequently continuing collecting and providing a real-time actual-temperature numerical value, as the current effect numerical value;

the smart gateway, after receiving the subsequently provided real-time actual-temperature numerical value, determining to trigger the second action resource;

the smart gateway finding that the resource structure of the second action resource action2 does not have a checking resource, and thus not checking;

the smart gateway reading the functioning duration effectTime in the first action-effect resource action2DesiredEffect1 of the second action resource action2, and the functioning duration effectTime in the first action-effect resource action1DesiredEffect1 of the first action resource action1; and

the smart gateway, after finding that the functioning duration effectTime in action2DesiredEffect1 and the functioning duration effectTime in action1DesiredEffect1 have a conflict therebetween, and the current moment falls within the functioning duration effectTime in action1DesiredEffect1, determining to continue executing action1, and not executing the later triggered second action resource action2.

In the embodiment of the present disclosure, the first action resource contains an identifier of the first smart device, a triggering condition of the first smart device, an execution instruction of the first smart device, a first action-effect resource setting forth the first execution effect of the first action resource and so on, and the first action-effect resource contains an identifier of a related second smart device. The monitoring on the two action resources of the first smart device corresponding to the first action resource is introduced, when the second action resource is triggered, it is checked whether the functioning durations in the action-effect resources in the two action resources have a conflict therebetween, and if a conflict exists, then the action resource that the functioning duration consistent with one current moment belongs to is selected to be executed. Therefore, the conflict between the action resources can be solved based on the functioning durations in the action-effect resources, whereby the controlling is more accurate and has a higher efficiency, thereby facilitating energy saving.

Still another method for controlling a smart device based on an action resource will be introduced below, wherein the differences from the above-described method for controlling a smart device based on an action resource will be introduced emphatically, and the same points will be omitted to the greatest extent.

For example, in the step S204, the step of, according to the real-time monitored data, solving the conflict between the later-triggered second action resource and the first action resource comprises: when the real-time first monitored data provided by the first sensor trigger a second action resource, according to a triggering condition in the first action resource and the first action-effect information, determining a first effect trend corresponding to the first action resource; according to a triggering condition in the second action resource and third action-effect information, determining a second effect trend corresponding to the second action resource; when the first effect trend corresponding to the first action resource and the second effect trend corresponding to the second action resource are opposite, determining whether a status value of a parameter of no-same-effect excluding a standard attribute in the second action resource is true, and whether a status value of a parameter of no-opposite-effect is false; when the status value of the parameter of no-same-effect is true and the status value of the parameter of no-opposite-effect is false, determining whether an execution object in the first action resource and an execution object in the second action resource are a same one object; if yes, then continuing executing the first action resource, and ignoring the second action resource; and if no, then continuing executing the first action resource, and starting to execute the second action resource.

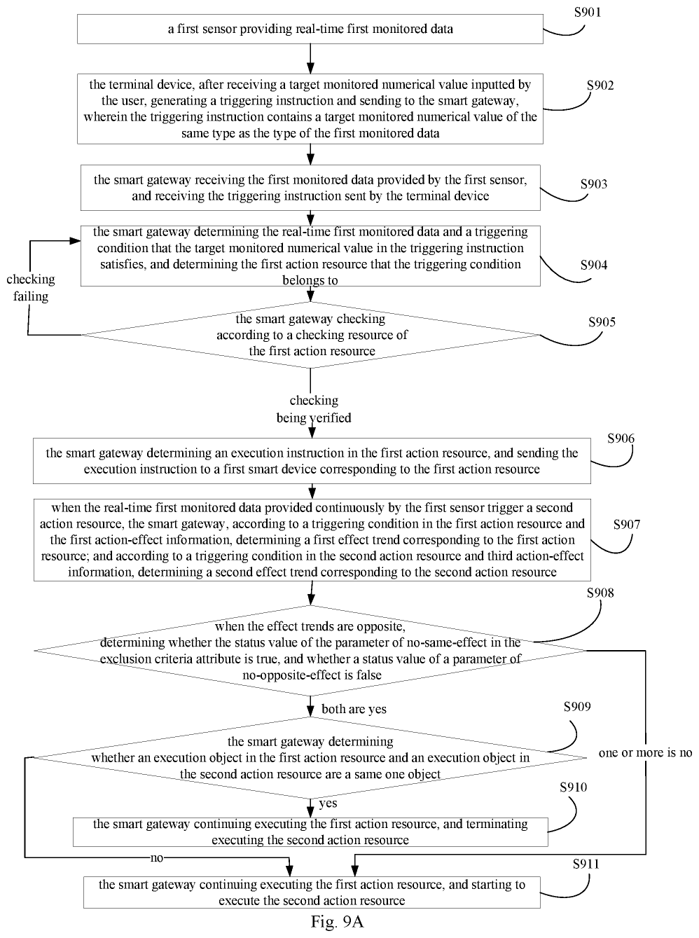

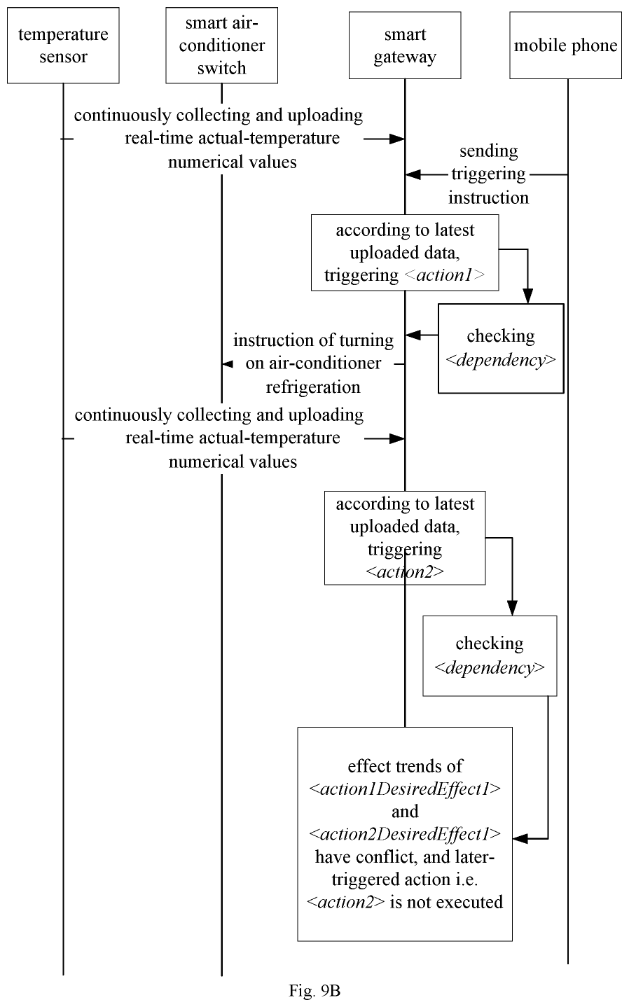

For example, a schematic flow chart of still another method for controlling a smart device based on an action resource is shown in FIG. 9A, which comprises the following steps S901-S911.

S901: a first sensor providing real-time first monitored data.

For example, the method of S901 is the same as the method of S601, and is not discussed further.

The step S901 starts to be executed before S902, and continues till, after S908, a shutting-down instruction dispatched by the smart gateway has been received.

S902: the terminal device, after receiving a target monitored numerical value inputted by the user, generating a triggering instruction and sending to the smart gateway, wherein the triggering instruction contains a target monitored numerical value of the same type as the type of the first monitored data.

For example, the method of S902 is the same as the method of S602, and is not discussed further.

S903: the smart gateway receiving the first monitored data provided by the first sensor, and receiving the triggering instruction sent by the terminal device.

For example, the method of S903 is the same as the method of S603, and is not discussed further.

S904: the smart gateway determining the real-time first monitored data and a triggering condition that the target monitored numerical value in the triggering instruction satisfies, and determining a first action resource containing the triggering condition.

For example, the method of S904 is the same as the method of S604, and is not discussed further.

S905: the smart gateway checking according to a checking resource of the first action resource; if the checking fails, then jumping to the step S903; and if the checking is verified, then executing the step S906.

For example, the step of the smart gateway checking according to a checking resource of the action resource comprises: determining whether an smart device having the effect opposite to that of the first smart device is being executed, if yes, then the checking failing, terminating sending the execution instruction to the first smart device corresponding to the first action resource, and ending the process or jumping to the step S903; and if the checking is verified, then executing the step S906.

For example, the method of S905 is the same as the method of S605, and is not discussed further.

S906: the smart gateway determining an execution instruction in the first action resource, and sending the execution instruction to a first smart device corresponding to the first action resource.

For example, the method of S9065 is the same as the method of S606, and is not discussed further.

For example, a sensor is the temperature sensor of a parlour, and the parameters of the first action resource include a triggering condition subject, an execution instruction input and an execution object object. The triggering condition subject, the execution instruction input and the execution object object are set to be a temperature greater than 30 degrees, starting up the refrigeration, and a smart air-conditioner switch respectively. The first action-effect resource action1DesiredEffect1 of the first action resource action1 contains the following parameters: an target effect numerical value effect Target Value. The correspondingly set value of the target effect numerical value effect Target Value is 26 degrees Celsius.

For example, this step comprises: the smart gateway determining an execution instruction in the first action resource, and sending the execution instruction to a first smart device corresponding to the first action resource, and the first smart device performing a starting-up operation in response to receiving the execution instruction.

S907: when the real-time first monitored data provided continuously by the first sensor trigger a second action resource, the smart gateway, according to a triggering condition in the first action resource and the first action-effect information, determining a first effect trend corresponding to the first action resource; and according to a triggering condition in the second action resource and third action-effect information, determining a second effect trend corresponding to the second action resource.

For example, after the first smart device has been started up in the above step, this step starts, and this step comprises the parlour temperature sensor continuing continuously collecting and providing the real-time actual-temperature numerical values, triggering the second action resource, and determining the target effect numerical value in the first action-effect resource action2DesiredEffect1 of the second action resource action2, and the target effect numerical value in the first action-effect resource action1DesiredEffect1 of the first action resource action1;

according to the triggering condition of the second action resource action2, and the second target effect numerical value in the first action-effect resource action2DesiredEffect1 of the second action resource action2, determining the second effect trend of the second action resource action2; and

according to the triggering condition of the first action resource action1, and the first target effect numerical value in the first action-effect resource action1DesiredEffect1 of the first action resource action1, determining the first effect trend of the first action resource action1.

For example, the second action resource action2 contains the first action-effect resource action2DesiredEffect1, and the checking resource is not provided. The parameters of the second action resource action2 include a triggering condition subject, an execution instruction input and an execution object object. The triggering condition subject, the execution instruction input and the execution object object are set to be a temperature less than 18 degrees, starting up the heating, and a smart air-conditioner switch respectively. The first action-effect resource action2DesiredEffect1 of the second action resource action2 contains the following parameters: an target effect numerical value effect Target Value. The correspondingly set value of the target effect numerical value effect Target Value is 27 degrees Celsius. The smart gateway determines that the triggering condition of the second action resource action2 is that the temperature is less than 18 degrees to the second target effect numerical value 27 degrees, and the second effect trend is temperature increasing. The triggering condition subject of the first action resource action1 is that the temperature is greater than 30 degrees to the first target effect numerical value 26 degrees, and the first effect trend is temperature decreasing.

For example, the action resource further contains an exclusion criteria attribute exclusionCriteria, and the exclusion criteria attribute exclusionCriteria contains at least one of the following parameters: no-same-effect noSameEffect, no-opposite-effect noOppositeEffect and no-same-object noSameObject.

For example, the status value of the parameter of no-same-effect noSameEffect, the status value of the parameter of no-opposite-effect noOppositeEffect and the status value of the parameter of no-same-object noSameObject in each of the exclusion criteria attributes may be set and updated according to experimentation data, empirical data, historical operation data and/or user-inputted data.

For example, the parameters in each of the exclusion criteria attributes may be updated in the historical usage process of the action resources. For example, this step comprises: in the historical usage process, the smart gateway, after determining that the effect trend of an action resource that has already been executed (for example, the first action resource) is temperature decreasing, and the effect trend of another later-triggered action resource (for example, the second action resource) is temperature increasing, updating the status value of the parameter of no-same-effect noSameEffect in the exclusion criteria attribute of the another later-triggered action resource into true True, and updating the status value of the parameter of no-opposite-effect noOppositeEffect into false False; and the smart gateway, according to the execution object object in the triggering condition of the action resource that has already been executed, and the execution object object in the triggering condition of the another later-triggered action resource, updating the status value of the parameter of no-same-object noSameObject.

For example, this step comprises: firstly operating the first action resource action1, subsequently triggering the second action resource action2, and the smart gateway, after determining that the first effect trend of the first action resource action1 is temperature decreasing, and the second effect trend of the second action resource action2 is temperature increasing, updating the status value of the parameter of no-same-effect noSameEffect in the exclusion criteria attribute of the later-triggered second action resource into true True, and updating the status value of the parameter of no-opposite-effect noOppositeEffect into false False; and the smart gateway reading the status value of the execution object object in the triggering condition of the first action resource action1 as a smart air-conditioner switch, reading the status value of the execution object object in the triggering condition of the later-triggered second action resource as a smart air-conditioner switch, and updating the status value of the parameter of no-same-object noSameObject into false False.

S908: when the first effect trend corresponding to the first action resource and the second effect trend corresponding to the second action resource are opposite, the smart gateway determining whether a status value of the parameter of no-same-effect noSameEffect excluding a standard attribute in the second action resource is true, and whether a status value of the parameter of no-opposite-effect noOppositeEffect is false; if both are yes, then executing the step S909; and if one or more is no, then executing the step S911.

For example, this step comprises: the smart gateway reading the status value of the parameter of no-same-effect noSameEffect in the exclusion criteria attribute of the later-triggered second action resource, and the status value of the parameter of no-opposite-effect noOppositeEffect;

when the status value of the parameter of no-same-effect noSameEffect is true True, and the status value of the parameter of no-opposite-effect noOppositeEffect is false False, which indicates from another dimension that the first effect trend of the first action resource and the second effect trend of the second action resource are opposite, executing the step S909; and

when the status value of the parameter of no-same-effect noSameEffect is false False, or the status value of the parameter of no-opposite-effect noOppositeEffect is true True, which indicates from another dimension that the first effect trend of the first action resource and the second effect trend of the second action resource are not opposite, then executing the step S911.

S909: the smart gateway determining whether an execution object in the first action resource and an execution object in the second action resource are a same one object; if yes, then executing S910; and if no, then executing S911.

For example, this step comprises: when the status value of the parameter of no-same-effect noSameEffect of the later-triggered second action resource is true True, and the status value of the parameter of no-opposite-effect noOppositeEffect is false False, the smart gateway reading the status value of the parameter of no-same-object noSameObject in the exclusion criteria attribute of the later-triggered second action resource, and determining whether the read status value of the parameter of no-same-object noSameObject is false; if it is false, which indicates that the first action resource that has already been executed and the later-triggered second action resource have the same object, and the objects have a conflict, executing S910; and if it is true, which indicates that the execution objects of the first action resource that has already been executed and the later-triggered second action resource are different, and the objects have no conflict, executing S911.

For example, this step comprises: the smart gateway reading the status value of the parameter of no-same-object noSameObject in the exclusion criteria attribute of the later-triggered second action resource action2, and, because the read status value of the parameter of no-same-object noSameObject is false, which indicates that the first action resource action1 that has already been executed and the later-triggered second action resource action2 have the same object, and the objects have a conflict, executing S909.

S910: the smart gateway continuing executing the first action resource, and ignoring the second action resource.

For example, this step comprises: when the second effect trend of the subsequent second action resource and the first effect trend of the existing first action resource are opposite, the smart gateway determining to continue executing the first action resource action1, and ignoring the second action resource action2.

S911: the smart gateway continuing executing the first action resource, and starting to execute the second action resource.

An example of still another method for controlling a smart device based on an action resource will be introduced below with reference to the drawings.

As shown in FIG. 9B, the method comprises: the temperature sensor continuously collecting real-time actual-temperature numerical values and continuously providing to the smart gateway;

the mobile phone sending to the smart gateway a triggering instruction containing a target monitored temperature;

the smart gateway, after receiving that triggering instruction, according to the lately provided actual-temperature numerical value, determining that the triggering condition of the first action resource action1 is satisfied, and the first action resource action1 being triggered;

the smart gateway checking the first action resource, and if the checking is verified, sending a refrigeration starting-up instruction to the smart air-conditioner switch;

the smart air-conditioner switch, according to the refrigeration starting-up instruction, starting up the air conditioner for the refrigeration;

the temperature sensor subsequently continuing collecting and providing a real-time actual-temperature numerical value, as the current effect numerical value;

the smart gateway, after receiving the subsequently provided real-time actual-temperature numerical value, determining to trigger the second action resource action2;

the smart gateway finding that the resource structure of the second action resource action2 does not have a checking resource, and thus not checking;

the smart gateway reading the second target effect numerical value in the first action-effect resource action2DesiredEffect1 of the second action resource action2 and the triggering condition in the second action resource action2, and in turn, according to the second target effect numerical value of the first action-effect resource action2DesiredEffect1 of the second action resource action2 and the triggering condition in the second action resource, determining the second effect trend of the first action-effect resource action2DesiredEffect1 of the second action resource action2;

the smart gateway reading the first target effect numerical value in the first action-effect resource action1DesiredEffect1 of the first action resource action1 and the triggering condition of the first action resource, and, according to the first target effect numerical value of the first action-effect resource action1DesiredEffect1 of the first action resource action1 and the triggering condition in the first action resource, determining the first effect trend of the first action-effect resource action1DesiredEffect1 of the first action resource action1; and

if the second effect trend in the first action-effect resource action2DesiredEffect1 of the second action resource action2 and the first effect trend in the first action-effect resource action1DesiredEffect1 of the first action resource action1 have a conflict therebetween, then the smart gateway continuing executing the first action resource action1, and not executing the later triggered second action resource action2.

In the embodiment of the present disclosure, the first action resource contains an identifier of the first smart device, a triggering condition of the first smart device, an execution instruction of the first smart device, a first action-effect resource setting forth the first execution effect of the first action resource and so on, and the first action-effect resource contains an identifier of a related second smart device. The monitoring on the two action resources of the first smart device corresponding to the first action resource is introduced, when the second action resource is triggered, it is checked whether the trend effects in the action-effect resources in the two action resources have a conflict therebetween, and if a conflict exists, then the current first action resource continues to be executed and the later triggered second action resource is ignored. Therefore, the conflict between the action resources can be solved based on the effect trends of the action-effect resources, whereby the controlling is more accurate and has a higher efficiency, thereby facilitating energy saving.

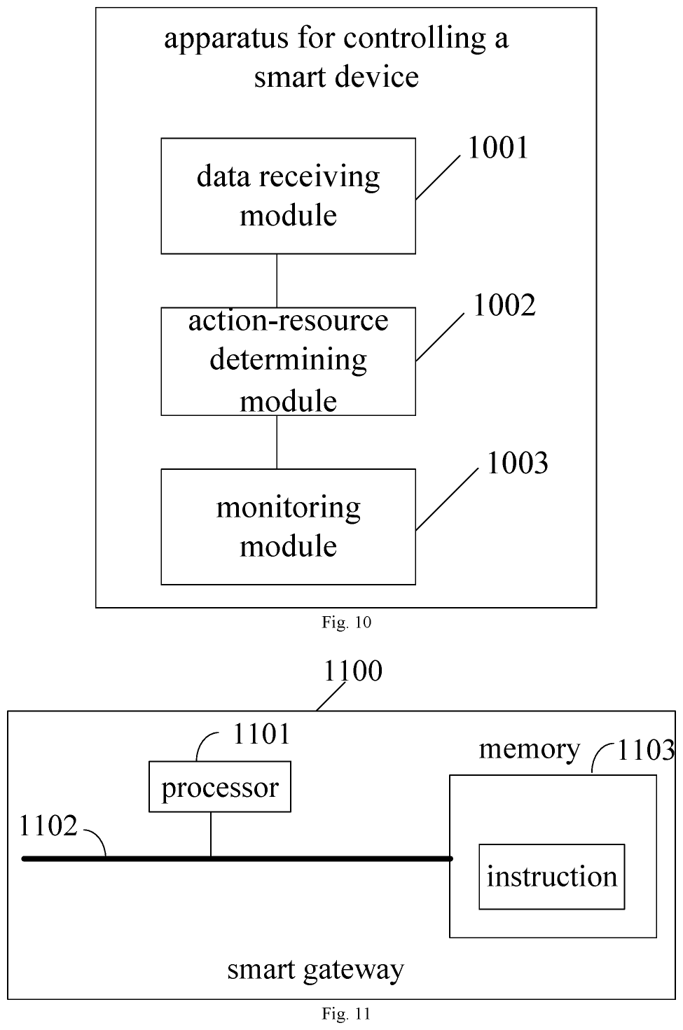

Based on the same concept, an embodiment of the present disclosure provides an apparatus for controlling a smart device. A structural block diagram of the apparatus is shown in FIG. 10, and the apparatus comprises: a data receiving module 1001, an action-resource determining module 1002 and a monitoring module 1003.

The data receiving module 1001 is configured for receiving first monitored data provided by a first sensor, and receiving a triggering instruction sent by a terminal device, wherein the triggering instruction contains a target monitored numerical value of the same type as the type of the monitored data; the action-resource determining module 1002 is configured for determining a triggering condition that real-time first monitored data and a target monitored numerical value satisfy, and determining a first action resource containing the triggering condition; determining an execution instruction in the first action resource, and sending the execution instruction to a first smart device corresponding to the first action resource; and the monitoring module 1003 is configured for, according to the real-time monitored data, monitoring a first execution effect corresponding to the first action resource, and according to a monitoring result of the first execution effect, starting up a second smart device related to the first smart device or shutting down the first smart device; and/or, according to the real-time monitored data, solving the conflict between the later-triggered second action resource and the first action resource.

For example, the monitoring module 1003 is configured for, according to the real-time first monitored data in the execution of the first action resource, updating a first starting effect numerical value in a first action-effect resource corresponding to the first execution effect; and according to the target monitored numerical value, updating a first target effect numerical value in the first action-effect resource; according to a first effect monitoring period in the first action-effect resource, receiving the real-time first monitored data, and updating a first current effect numerical value in the first action-effect resource; according to the first starting effect numerical value and the first target effect numerical value, determining a current-moment-predicted-reached numerical value; according to the updated first current effect numerical value and the current-moment-predicted-reached numerical value, determining whether the first execution effect is out-of-control, and updating the determination result to the status value of a first effect controlling trend in the first action-effect resource; if the execution effect is under-control, then continuing detection in the next period; and if the first execution effect is out-of-control, then determining whether a related second smart device or a related action resource is required to be involved.

For example, the monitoring module 1003 is configured for, according to the first starting effect numerical value, the first target effect numerical value, the first effect-predicted-reached period and the first effect monitoring period, determining an each-time-interval-predicted-reached effect; according to the time difference between the current moment and the initial moment, the first effect monitoring period and the each-time-interval-predicted-reached effect, determining a current-moment-predicted-reached numerical value, wherein the initial moment is the moment of sending the execution instruction in the first action resource.

For example, the monitoring module 1003 is configured for, according to the first effect controlling parameter in the first action-effect resource, and the current-moment-predicted-reached numerical value, determining the upper limit of the current-moment-predicted-reached numerical value and the lower limit of the current-moment-predicted-reached numerical value; and according to the upper limit of the current-moment-predicted-reached numerical value, the lower limit of the current-moment-predicted-reached numerical value and the updated first current effect numerical value, determining whether the first execution effect is out-of-control.

For example, the data receiving module 1001 is further configured for determining an execution instruction in the first action resource, and after sending the execution instruction to the first smart device corresponding to the first action resource, receiving second monitored data provided by a second sensor.

For example, the monitoring module 1003 is further configured for, according to another real-time monitored data, monitoring a second execution effect corresponding to the first action resource, and updating a second action-effect resource corresponding to the second execution effect; and when the monitoring result of the second execution effect is out-of-control, determining that it is required to shut down the first smart device, and executing an operation instruction opposite to the execution instruction.

For example, the monitoring module 1003 is configured for, when the second action resource is triggered by real-time monitored data subsequently provided by the sensor, determining a functioning duration in the second action resource and a functioning duration in the first action resource; when the functioning duration in the first action resource contains the current moment, continuing executing the first action resource, and ignoring the second action resource; and when the functioning duration in the second action resource contains the current moment, executing the second action resource, and terminating executing the first action resource.

For example, the monitoring module 1003 is configured for, when the second action resource is triggered by the real-time second monitored data subsequently provided by the first sensor, according to a triggering condition in the first action resource and the first action-effect information, determining a first effect trend corresponding to the first action resource; according to a triggering condition in the second action resource and third action-effect information, determining a second effect trend corresponding to the second action resource; when the first effect trend corresponding to the first action resource and the second effect trend corresponding to the second action resource are opposite, determining whether a status value of a parameter of no-same-effect excluding a standard attribute in the second action resource is true, and whether a status value of a parameter of no-opposite-effect is false; when the status value of the parameter of no-same-effect is true and the status value of the parameter of no-opposite-effect is false, determining whether an execution object in the first action resource and an execution object in the second action resource are a same one object; if yes, then continuing executing the first action resource, and ignoring the second action resource; and if no, then continuing executing the first action resource, and starting to execute the second action resource.

For example, the action-resource determining module 1002 is further configured for determining an execution instruction in the action resource, and, before sending to the first smart device of the action resource, checking according to a checking resource of the first action resource, comprising: determining whether an smart device having the effect opposite to that of the first smart device is being executed, if yes, then the checking failing, and terminating sending the execution instruction to the first smart device corresponding to the first action resource; and if no, the checking being verified.

The apparatus for controlling a smart device according to the present embodiment may implement the method for controlling a smart device according to any one of the above embodiments of the present disclosure, with a similar principle of implementation, which is not discussed here further.

Based on the same concept, an embodiment of the present disclosure provides a smart gateway, wherein the smart gateway comprises: a processor; a memory communicatively connected to the processor; and at least one instruction, stored in the memory, and configured for, when executed by the processor, implementing the method for controlling a smart device according to any one of the above items of the present disclosure.

For example, the smart gateway according to the embodiment of the present disclosure is shown in FIG. 11, and the electronic device 1100 shown in FIG. 11 comprises: a processor 1101 and a memory 1103. The processor 1101 and the memory 1103 are electrically connected, for example, connected by a bus 1102. The structure of the electronic device 1100 does not limit the embodiments of the present disclosure.

The processor 1101 is applied to the embodiments of the present disclosure, and is configured for realizing the functions of the modules shown in FIG. 11.

The processor 1101 may be a CPU (Central Processing Unit), a generic processor, a DSP (Digital Signal Processor), an ASIC (Application Specific Integrated Circuit), a FPGA (Field-Programmable Gate Array) or another programmable logic device, transistor logic device, hardware component or any combination thereof. It may realize or implement various exemplary logic blocks, modules and electric circuits described with reference to the disclosure of the present disclosure. The processor 1101 may also be a combination realizing the function of calculation, for example, the combination of one or more microprocessors, the combination of a DSP and a microprocessor, and so on.

The bus 1102 may comprise a passage, for transmitting information between the above components. The bus 1102 may be a PCI (Peripheral Component Interconnect) bus or an EISA (Extended Industry Standard Architecture) bus and so on. The bus 1102 may comprise an address bus, a data bus, a control bus and so on. In order to facilitate the illustration, it is represented by a thick line in FIG. 11, but the present embodiment is not limited to having one bus or one type of bus.

The memory 1103 may be an ROM (Read-Only Memory) or another type of static storage device that can store static information and instructions, and an RAM (random access memory) or another type of dynamic storage device that can store information and instructions, may also be an EEPROM (Electrically Erasable Programmable Read Only Memory), a CD-ROM (Compact Disc Read-Only Memory) or another optical disk storage, optical disc storage (including a compressed optical disc, a laser optical disc, an optical disc, a Digital Versatile Disc, a blue-ray optical disc and so on), magnetic-disk storage medium or another magnetic storage device, or any other mediums that can be used to carry or store a desired program code in the form of an instruction or a data structure and can be accessed by a computer, but is not limited thereto.

For example, the memory 1103 is configured for storing an application program code for performing the solution of the present disclosure, and is controlled by the processor 1101 with respect to the implementation. The processor 1101 is configured for executing the application program code stored in the memory 1103, to implement the method for controlling a smart device of any one of the items according to the present disclosure.

Based on the same concept, an embodiment of the present disclosure provides a computer-readable storage medium, wherein the computer-readable storage medium stores a computer program, and the computer program, when executed by a processor, implements the method for controlling a smart device according to any one of the above items of the present disclosure.

An embodiment of the present disclosure provides a computer-readable storage medium, adapted for the various alternative embodiments of the method for controlling a smart device according to any one of the above items, which is not discussed here further.

A person skilled in the art can understand that the steps, measures and solutions in the various operations, methods and processes that have been discussed in the present disclosure may be substituted, modified, combined or deleted. Further, the other steps, measures and solutions in the various operations, methods and processes that have been discussed in the present disclosure may be substituted, modified, rearranged, decomposed, combined or deleted. Further, the steps, measures and solutions in the various operations, methods and processes disclosed in the present disclosure in the related art may be substituted, modified, rearranged, decomposed, combined or deleted.

The terms “first” and “second” are for the purpose of describing, and should not be construed as indicating or implying the degrees of importance or implicitly indicating the quantity of the specified technical features. Accordingly, the features defined by “first” or “second” may explicitly or implicitly comprise one or more of the features. In the description of the present disclosure, unless stated otherwise, the meaning of “plurality of” is “two or more”.

In the description of the present disclosure, it should be noted that, unless explicitly defined or limited otherwise, the terms “mount”, “connect” and “link” should be interpreted broadly. For example, it may be fixed connection, detachable connection, or integral connection; and it may be direct connection or indirect connection by an intermediate medium, and may be the internal communication between two elements. For a person skilled in the art, the meanings of the above terms in the present disclosure should be comprehended according to actual situations.

In the description of the present disclosure, the features, structures, materials or characteristics may be combined in any one or more embodiments or examples in a suitable form.

It should be understood that, although the steps in the flow charts in the drawings are shown sequentially according to the indication by the arrows, those steps are not necessarily performed sequentially according to the sequence indicated by the arrows. Unless expressly described herein, the sequence of the performances of those steps are not strictly limited, and they may be performed in other sequences. Furthermore, at least some of the steps in the flow charts in the drawings may comprise a plurality of sub-steps or a plurality of stages, wherein those sub-steps or stages are not necessarily completely performed at the same one moment, but may be performed at different moments, and their performance sequence is not necessarily sequential performance, but may be performance alternate with at least some of the other steps or the sub-steps or stages of the other steps.

The above-described are some of the embodiments of the present disclosure. It should be noted that a person skilled in the art may make various improvements without departing from the principle of the present disclosure, wherein those improvements should be considered as falling within the protection scope of the present disclosure.

1. A method for controlling a smart device, wherein the method comprises:
receiving first monitored data provided by a first sensor;
determining a relation that the first monitored data and a preset target monitored numerical value satisfy;
determining an action resource among a plurality of preset action resources that contains a triggering condition matching with the relation as a first action resource;
extracting an execution instruction from the first action resource, and sending the execution instruction to a first smart device related to the first action resource; and
according to the first monitored data, monitoring a first execution effect of the first smart device related to the first action resource, and according to the first execution effect, starting up a second smart device related to the first smart device or shutting down the first smart device.

2. The method according to claim 1, wherein the method further comprises:
when the first monitored data provided by the first sensor trigger a second action resource, extracting a functioning duration of the second action resource from the second action resource, and extracting a functioning duration of the first action resource from the first action resource;
if a current moment falls within a time period of the functioning duration of the first action resource, continuing executing the first action resource, and terminating executing the second action resource; and
if a current moment falls within a time period of the functioning duration of the second action resource, executing the second action resource, and terminating executing the first action resource.

3. The method according to claim 1, wherein the first action resource contains first action-effect information, and the first action-effect information contains a first effect monitoring period, a first starting effect numerical value, a first current effect numerical value, a first target effect numerical value and a first effect controlling trend; and
the step of, according to the first monitored data, monitoring the first execution effect of the first smart device related to the first action resource comprises:
according to the first monitored data, updating the first starting effect numerical value in the first action-effect information, and according to the target monitored numerical value, updating the first target effect numerical value in the first action-effect information;
according to the first effect monitoring period in the first action-effect information, receiving the first monitored data, according to the received first monitored data, updating the first current effect numerical value in the first action-effect information, and according to the first starting effect numerical value and the first target effect numerical value, determining a current-moment-predicted-reached numerical value, according to a relation between the updated first current effect numerical value and the current-moment-predicted-reached numerical value, determining whether the first execution effect is out-of-control or under-control, and updating a determination result to a status value of the first effect controlling trend in the first action-effect information;
if the first execution effect is under-control, then continuing detection in a next period; and
if the first execution effect is out-of-control, then starting up the second smart device or, according to the first execution effect, selecting another action resource from the plurality of predetermined action resources as the first action resource.

4. The method according to claim 3, wherein the first action-effect information further contains a first effect-predicted-reached period; and
the step of, according to the first starting effect numerical value and the first target effect numerical value, determining the current-moment-predicted-reached numerical value comprises:
according to the first starting effect numerical value and the first target effect numerical value, and according to the first effect-predicted-reached period and the first effect monitoring period, determining a predictively reached effect; and
according to a time difference between a current moment and an initial moment and the predictively reached effect, determining the current-moment-predicted-reached numerical value, wherein the initial moment is a moment of sending the execution instruction in the first action resource.

5. The method according to claim 3, wherein the first action-effect information further contains a first effect controlling parameter; and
the step of, according to the relation between the updated first current effect numerical value and the current-moment-predicted-reached numerical value, determining whether the first execution effect is out-of-control or under-control comprises:
according to the first effect controlling parameter in the first action-effect information and the current-moment-predicted-reached numerical value, determining an upper limit of the current-moment-predicted-reached numerical value and a lower limit of the current-moment-predicted-reached numerical value; and
according to a relation between the updated first current effect numerical value and the upper limit of the current-moment-predicted-reached numerical value and the lower limit of the current-moment-predicted-reached numerical value, determining whether the first execution effect is out-of-control.

6. The method according to claim 3, wherein the first action resource further contains second action-effect information;
the method further comprises: receiving second monitored data provided by a second sensor; and
the step of, according to the first monitored data, monitoring the first execution effect of the first smart device related to the first action resource, and according to the first execution effect, shutting down the first smart device comprises:
according to the second monitored data, monitoring a second execution effect of the first smart device related to the first action resource, and updating the second action-effect information in the first action resource corresponding to the second execution effect; and
when a difference between the second execution effect and a predetermined effect exceeds a predetermined range, determining that the second execution effect is out-of-control, and according to the second execution effect, shutting down the first smart device.

7. The method according to claim 3, wherein the method further comprises: triggering, by the received first monitored data provided by the first sensor, the second action resource, wherein the second action resource comprises third action-effect information, and the third action-effect information contains a second target effect numerical value; and
the method further comprises:
according to the triggering condition in the first action resource and the first target effect numerical value in the first action-effect information in the first action resource, determining a first effect trend corresponding to the first action resource, and according to the triggering condition in the second action resource and the second target effect numerical value in the third action-effect information in the second action resource, determining a second effect trend corresponding to the second action resource;
when the first effect trend corresponding to the first action resource and the second effect trend corresponding to the second action resource are opposite, determining whether a status value of a parameter of no-same-effect in the second action resource is true, and whether a status value of a parameter of no-opposite-effect is false; and
when the status value of the parameter of no-same-effect is true and the status value of the parameter of no-opposite-effect is false, determining whether an execution object in the first action resource and an execution object in the second action resource are a same one object, if yes, then continuing executing the first action resource, and terminating executing the second action resource, and if no, then continuing executing the first action resource, and starting to execute the second action resource.

8. The method according to claim 3, wherein
the first action-effect information is stored as a sub-resource of the first action resource, or is stored as a parameter of the first action resource; and
the triggering condition in the first action resource is stored as a parameter of the first action resource.

9. The method according to claim 8, wherein the first action resource further contains first checking information, and the first checking information is stored as a sub-resource of the first action resource.

10. The method according to claim 1, wherein the method further comprises: receiving a triggering instruction inputted by a user, and extracting the preset target monitored numerical value from the received triggering instruction.

11. A smart gateway, wherein the smart gateway comprises:
a processor; and
a memory, wherein the memory is communicatively connected to the processor;
wherein the memory stores at least one instruction, and the at least one instruction, when executed by the processor, is configured for implementing operations for controlling a smart device, the operations comprise:
receiving first monitored data provided by a first sensor;
determining a relation that the first monitored data and a preset target monitored numerical value satisfy;
determining an action resource among a plurality of preset action resources that contains a triggering condition matching with the relation as a first action resource;
extracting an execution instruction from the first action resource, and sending the execution instruction to a first smart device related to the first action resource; and
according to the first monitored data, monitoring a first execution effect of the first smart device related to the first action resource, and according to the first execution effect, starting up a second smart device related to the first smart device or shutting down the first smart device.

12. The smart gateway according to claim 11, wherein the operations further comprise:
when the first monitored data provided by the first sensor trigger a second action resource, extracting a functioning duration of the second action resource from the second action resource, and extracting a functioning duration of the first action resource from the first action resource;
if a current moment falls within a time period of the functioning duration of the first action resource, continuing executing the first action resource, and terminating executing the second action resource; and
if a current moment falls within a time period of the functioning duration of the second action resource, executing the second action resource, and terminating executing the first action resource.

13. The smart gateway according to claim 11, wherein the first action resource contains first action-effect information, and the first action-effect information contains a first effect monitoring period, a first starting effect numerical value, a first current effect numerical value, a first target effect numerical value and a first effect controlling trend; and
the step of, according to the first monitored data, monitoring the first execution effect of the first smart device related to the first action resource comprises:
according to the first monitored data, updating the first starting effect numerical value in the first action-effect information, and according to the target monitored numerical value, updating the first target effect numerical value in the first action-effect information;
according to the first effect monitoring period in the first action-effect information, receiving the first monitored data, according to the received first monitored data, updating the first current effect numerical value in the first action-effect information, and according to the first starting effect numerical value and the first target effect numerical value, determining a current-moment-predicted-reached numerical value, according to a relation between the updated first current effect numerical value and the current-moment-predicted-reached numerical value, determining whether the first execution effect is out-of-control or under-control, and updating a determination result to a status value of the first effect controlling trend in the first action-effect information;
if the first execution effect is under-control, then continuing detection in a next period; and
if the first execution effect is out-of-control, then starting up the second smart device or, according to the first execution effect, selecting another action resource from the plurality of predetermined action resources as the first action resource.

14. The smart gateway according to claim 13, wherein the first action-effect information further contains a first effect-predicted-reached period; and
the step of, according to the first starting effect numerical value and the first target effect numerical value, determining the current-moment-predicted-reached numerical value comprises:
according to the first starting effect numerical value and the first target effect numerical value, and according to the first effect-predicted-reached period and the first effect monitoring period, determining a predictively reached effect; and
according to a time difference between a current moment and an initial moment and the predictively reached effect, determining the current-moment-predicted-reached numerical value, wherein the initial moment is a moment of sending the execution instruction in the first action resource.

15. The smart gateway according to claim 13, wherein the first action-effect information further contains a first effect controlling parameter; and
the step of, according to the relation between the updated first current effect numerical value and the current-moment-predicted-reached numerical value, determining whether the first execution effect is out-of-control or under-control comprises:
according to the first effect controlling parameter in the first action-effect information and the current-moment-predicted-reached numerical value, determining an upper limit of the current-moment-predicted-reached numerical value and a lower limit of the current-moment-predicted-reached numerical value; and
according to a relation between the updated first current effect numerical value and the upper limit of the current-moment-predicted-reached numerical value and the lower limit of the current-moment-predicted-reached numerical value, determining whether the first execution effect is out-of-control.

16. The smart gateway according to claim 13, wherein the first action resource further contains second action-effect information;
the operations further comprise: receiving second monitored data provided by a second sensor; and
the step of, according to the first monitored data, monitoring the first execution effect of the first smart device related to the first action resource, and according to the first execution effect, shutting down the first smart device comprises:
according to the second monitored data, monitoring a second execution effect of the first smart device related to the first action resource, and updating the second action-effect information in the first action resource corresponding to the second execution effect; and
when a difference between the second execution effect and a predetermined effect exceeds a predetermined range, determining that the second execution effect is out-of-control, and according to the second execution effect, shutting down the first smart device.

17. The smart gateway according to claim 13, wherein the operations further comprise:
triggering, by the received first monitored data provided by the first sensor, the second action resource, wherein the second action resource comprises third action-effect information, and the third action-effect information contains a second target effect numerical value; and
the operations further comprise:
according to the triggering condition in the first action resource and the first target effect numerical value in the first action-effect information in the first action resource, determining a first effect trend corresponding to the first action resource, and according to the triggering condition in the second action resource and the second target effect numerical value in the third action-effect information in the second action resource, determining a second effect trend corresponding to the second action resource;
when the first effect trend corresponding to the first action resource and the second effect trend corresponding to the second action resource are opposite, determining whether a status value of a parameter of no-same-effect in the second action resource is true, and whether a status value of a parameter of no-opposite-effect is false; and
when the status value of the parameter of no-same-effect is true and the status value of the parameter of no-opposite-effect is false, determining whether an execution object in the first action resource and an execution object in the second action resource are a same one object, if yes, then continuing executing the first action resource, and terminating executing the second action resource, and if no, then continuing executing the first action resource, and starting to execute the second action resource.

18. A system for controlling a smart device, wherein the system comprises:
the smart gateway according to claim 11;
the first sensor, communicatively connected to the smart gateway, configured for continuously collecting the first monitored data and sending the first monitored data to the smart gateway; and
a terminal device, communicatively connected to the smart gateway, configured for providing a triggering instruction to the smart gateway, wherein the triggering instruction contains a target monitored numerical value of a same type as a type of the monitored data.

19. The system according to claim 18, wherein the system further comprises:
a second sensor, communicatively connected to the smart gateway, configured for continuously collecting second monitored data and sending the second monitored data to the smart gateway.

20. A computer-readable storage medium, storing a computer program, wherein the computer program, when executed by a processor, implements the method for controlling a smart device according to claim 1.
